(19) United States
(12) Patent Application Publication
(10) Pub. No.: US 2009/0267837 A1
(43) Pub. Date: Oct. 29, 2009

(54) Arrival-Time Locked Loop

(76) Inventor: Wen T. Lin, Ambler, PA (US)

Correspondence Address: FOX ROTHSCHILD LLP, P O BOX 592, 112 NASSAU STREET, PRINCETON, NJ, 08542-0592, US

(21) Appl. No.: 11/913,731

(22) PCT Filed: May 4, 2006
(86) PCT No.: PCT/US06/17856

§ 371 Date: Nov. 6, 2007

Related U.S. Application Data
(60) Provisional application No. 60/757,645, filed on Jan. 10, 2006.
(60) Provisional application No. 60/756,040, filed on Jan. 4, 2006.
(60) Provisional application No. 60/736,476, filed on Nov. 14, 2005.
(60) Provisional application No. 60/678,841, filed on May 6, 2005.

(51) Int. Cl. G01S 1/24

(52) U.S. Cl. 342/387

(57) ABSTRACT

This patent disclosure presents circuits, systems and methods to produce a stable signal from a reference signal source. These new inventions are far better than the current technologies to provide a stable signal with less phase noises. This new invention also provides a new approach to analyze the feedback control loop without using the traditional feedback control theory.

### CROSS REFERENCE TO APPLICATIONS

This application is related to, and claims priority from the following four U.S. Provisional Patent applications,

1. U.S. No. 60/678,841 entitled “Phase Locked Loop Having Optimal Dead Zone Operating Characteristics” filed on May 6, 2005 by W. T. Lin,

2. U.S. No. 60/736,476 entitled “Data Clock Recovery System Using Arrival-Time Detector” filed on Nov. 14, 2005 by W. T. Lin.

3. U.S. No. 60/756040 entitled “Arrival-time detector with double-ended charge pump output” filed on Jan. 4, 2006 by W. T. Lin;

4. U.S. No. 60/757645 entitled “Arrival-time detector with double-ended charge pump output” filed on Jan. 10, 2006 by W. T. Lin; and to PCT Patent application, PCT/US2005/026842 filed on Jul. 28, 2005, “A system, method and circuit to detect a phase, a frequency and an arrival-time difference between two signals” by Wen T. Lin, the entire contents of all of which are hereby incorporated by reference.

### TECHNICAL FIELD

The present invention relates to the field of digital signal processing, and more specifically, the present invention relates to methods, apparatus, and systems for generating a stable signal from a reference signal source.

### BACKGROUND ART

The phase locked loop (PLL) technology has been the mainstream technology for generating a stable signal from a reference signal source since it was first invented eighty years ago. The PLL is virtually used in every electronics product nowadays. Despite its popularity and widespread use for so long, the PLL is still a very difficult technology to use today. The most notorious problem with the current PLL technology is the “dead-zone jittering problem” that occurs when the two signals are locked by the PLL without phase offset. The current PLL theory simply can not explain why this problem happens. As a result, there are only many workaround solutions to this problem proposed during the past forty years but no real solution exists yet until now. And worst of all, since these workaround solutions have been used for so long, they have become the normal solutions and accepted by everybody and nobody asks question any more. The disadvantages of these workaround solutions are many, first of all, the operating speed of the PLL must be slowed down significantly and secondly, they always generate more phase noises for the VCO and thirdly and most importantly, the threat of dead-zone jittering is still there and the VCO can jitter excessively at any unpredictable moment. The “dead-zone jittering problem” was finally solved completely by using the arrival-time locked loop technology as proposed in the PCT application PCT/US2005/026842 filed on Jul. 28, 2005. The concept of arrival-time can fully explain why the dead-zone jittering occurred and provide a true solution to this problem.

The original design of the arrival-time detectors used in the arrival-time locked loop, as presented in the application PCT/US2005/026842, can only be operated with a single-ended charge pump output driver which usually requires an OPAMP to provide a constant bias voltage for the charge pump output driver. The single-ended charge pump output driver of the arrival-time detector produces a decision output with a very small decision uncertainty. It is a great design but it is also more difficult to implement and requires more hardware. A balanced double-ended charge pump output is always easier to use and is more forgiving to the mismatches of the IC layout due to its balanced nature. Although the balanced double-ended charge pump output driver of the arrival-time detector produces an output with a larger decision uncertainty, the decision output is still always precise and accurate. An arrival-time detector with a balanced double-ended charge pump output driver is thus very desirable and will be more popular than an arrival-time detector with a single-ended charge pump output driver.

### DISCLOSURE OF INVENTION

In the beginning of the first part of this disclosure, the concept of arrival-time is used to explain the operation of traditional analog PLL and to provide a technique and method for analyzing the feedback control loop without using the traditional feedback control theory. The new concept and technique and method are then applied to the traditional PLL using PFD as the phase detector and the source of the dead zone jittering problem is fully explained. New solutions to solve the dead zone jittering problem are then provided. In the second part of this disclosure, the acquisition behavior of the arrival-time locked loop is investigated by using the new concept and technique and method. It is found that using the concept of arrival-time to explain the operation of arrival-time locked loop can not only produce exactly the same results as using the traditional feedback control theory but it also provides a lot more details about and insights into the operation of the arrival-time locked loop that are not easily conceivable by using the traditional feedback control theory.

Two new designs of arrival-time detector using single-ended charge pump output driver are illustrated in the disclosure. In the first design, an arrival-time detector with only a sinking charge pump as the output driver can only generates a negative output from the leading feedback signal from VCO. In the second design, an arrival-time detector with only a sourcing charge pump as the output driver can only generate a positive output from the leading reference signal. These two arrival-time detectors using single-ended charge pump output driver are then combined to become an arrival-time detector using double-ended charge pump output driver.

Three new designs of the digital arrival-time detectors using double-ended charge pump output driver are illustrated in this disclosure. In the first design of arrival-time detector with double-ended charge pump output, the duration of the enable signals to control the charge pumps is always longer than the actual arrival-time difference between the two input signals so that the charge pumps will always be fully turned on regardless of how small the arrival-time difference between the two input signals is.

In the second design, the duration of the enable signals to control the charge pumps is made exactly equal to the arrival-time difference between the two input signals. As a result, the charge pump output drivers exhibit a dead-zone and linear state so that the output from charge pumps will not be turned on at all until the arrival-time difference between the two input signals is long enough to overcome the dead time of the charge pumps and the output of charge pumps won't be turned on completely until the arrival-time difference between the two input signals is longer than the sum of dead-time and slew time of the charge pumps.

In the third design, the duration of the enabling signals to control the charge pumps is slightly longer than the arrival-time difference between the two input signals but still not long enough to fully turn on the charge pump output drivers when the arrival-time difference between the two input signals is zero. As a result, although the dead zone is prevented, the charge pump output drivers still exhibit a linear state around the decision threshold so that the output of charge pumps will not be turned on fully until the arrival-time difference between the two input signals is long enough to totally overcome the slew time of the charge pumps.

These and other features of the present invention will now be described in detail by reference to the following drawings.

### BRIEF DESCRIPTIONS OF THE DRAWINGS AND FIGURES

FIG. 1—The building blocks of a basic phase locked loop (prior art).

FIG. 2—The mixer as a phase detector (prior art).

FIG. 3—The transfer characteristic of the final error correction voltage to the VCO from a mixer as the arrival-time detector.

FIG. 4—The theoretical transfer characteristic for the gain of the analog arrival-time locked loop using mixer as the arrival-time detector.

FIG. 5—The actual transfer characteristic of the gain of the analog arrival-time locked loop using mixer as the arrival-time detector.

FIG. 6—The basic digital phase frequency detector with double-ended charge pumps (prior art).

FIG. 7—The timing diagram for the basic PFD with double-ended charge pumps.

FIG. 8—The transfer characteristic of the final error correction voltage to the VCO of an arrival-time locked loop using the PFD as shown in FIG. 6 as the arrival-time detector.

FIG. 9—The transfer characteristic of the gain of an arrival-time locked loop using the PFD as shown in the FIG. 6 as the arrival-time detector.

FIG. 10—The building blocks of a basic linear arrival-time locked loop as the preferred embodiment.

FIG. 11—The transfer characteristic of the final error correction voltage to the VCO of an arrival-time locked loop with a perfect arrival-time detector.

FIG. 12—The schematics of a typical digital arrival-time detector using a single-ended charge pump output with a dead-zone.

FIG. 13—The schematics of a typical digital arrival-time detector using a single-ended charge pump output without the dead-zone and linear state.

FIG. 14—The schematic of the perfect digital arrival-time detector with single-ended charge pump output without dead zone and linear state.

FIG. 15—The transfer characteristics of a perfect digital arrival-time detector with single-ended charge pump output without dead zone and linear state as shown in FIG. 14.

FIG. 16—The schematics of a digital arrival-time detector with only the sinking charge pump output as the first supplement embodiment.

FIG. 17—The transfer characteristic of the arrival-time detector with only sinking charge pump.

FIG. 18—The schematics of a digital arrival-time detector with only the sourcing charge pump output as the second supplement embodiment.

FIG. 19—The transfer characteristic of the arrival-time detector with only the sourcing charge pump output as shown in FIG. 18.

FIG. 20—The schematics of a perfect digital arrival-time detector using a double-ended charge pump output driver without dead zone and linear state as the third supplement embodiment.

FIG. 21—The transfer characteristic of the perfect digital arrival-time detector using a double-ended charge pump output driver as shown in FIG. 20.

FIG. 22—The schematics of a digital arrival-time detector using a double-ended charge pump output driver with a dead zone as the fourth supplement embodiment.

FIG. 23—The transfer characteristic of the digital arrival-time detector using a double-ended charge pump output driver with a dead zone as shown in FIG. 22.

FIG. 24—The transfer characteristic of the final error correction voltage output to the VCO from a digital arrival-time detector using a double-ended charge pump output driver with a dead zone as shown in FIG. 22.

FIG. 25—The transfer characteristic of the gain of the arrival-time locked loop using a digital arrival-time detector with double-ended charge pump output driver with a dead zone as shown in FIG. 22.

FIG. 26—The schematics of digital arrival-time detector using a double-ended charge pump output without dead zone but with a linear state as the fifth supplement embodiment.

FIG. 27—The schematics of the pulse width reducer.

FIG. 28—The transfer characteristic of the digital arrival-time detector using a double-ended charge pump output driver without a dead zone but with a linear state as shown in FIG. 26.

FIG. 29—The transfer characteristic of the final error correction voltage to the VCO from a digital arrival-time detector using double-ended charge pump output without a dead zone but with a linear state as shown in FIG. 26.

FIG. 30—The transfer characteristic of the gain of the arrival-time locked loop using the digital arrival-time detector with double-ended charge pump output without a dead zone but with a linear state as shown in FIG. 26.

FIG. 31—The acquisition behavior of a conceptual, ideal arrival-time locked loop without latency delay time and propagation delay time.

FIG. 32—The actual transfer characteristic of the final error correction voltage to the VCO of an arrival-time locked loop using a perfect digital arrival-time detector.

FIG. 33—The actual transfer characteristic of the loop gain of an arrival-time locked loop using a perfect digital arrival-time detector.

FIG. 34—The building blocks of a typical arrival-time locked loop with a frequency divider.

FIG. 35—The response time of the loop filter.

FIG. 36—The acquisition behavior of the arrival-time locked loop with loop delay time smaller than ¼ of the period of the natural frequency during the last cycle of the beat signal of the cycle-slip phase.

FIG. 37—The acquisition behavior of the arrival-time locked loop with loop delay time larger than ¼ of the period of the natural frequency during the last cycle of the beat signal of the cycle-slip phase.

FIG. 38—The block diagram of a feedback control loop (prior art)

FIG. 39—The arrival-time detector using only a sinking charge pump as the output driver as the six supplement embodiment.

FIG. 40—The arrival-time detector using only a sourcing charge pump as the output driver as the seventh supplement embodiment.

FIG. 41—A difference feedback control loop.

### BEST MODE FOR CARRYING OUT THE INVENTION

The present invention relates to systems and methods for implementing a linear arrival-time locked loop to produce a stable output signal from a reference signal source. The linear arrival-time locked loop originates from the traditional Phase Locked Loop (PLL) 105.

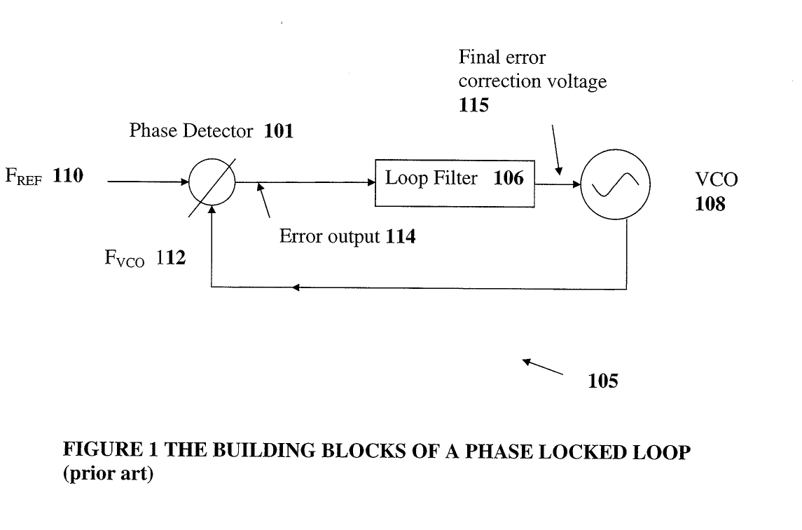

The traditional PLL 105 is a linear feedback control loop to synchronize a local signal 112 generated from a voltage controlled oscillator (VCO) 108 to an incoming reference signal 110 as shown in FIG. 1. The basic PLL 105 is made of three building blocks, the phase detector 101, loop filter 106 and VCO 108 to generate a local signal 112 with a frequency and phase that are the same as the frequency and phase of the reference signal 110. The phase detector 101 is a linear device to generate an error output signal 114 with the amplitude proportional to the phase difference between the local signal from VCO 112 and the reference signal 110. The error output signal 114, after being filtered out by the loop filter 106, becomes the final error correction output voltage 115 to correct the frequency of VCO 108. The feedback control loop will keep correcting the frequency of the VCO 108 until the error output signal 114 becomes zero and both the phase and frequency of the signal from VCO 112 are locked to the phase and frequency of the reference signal 110.

In the past, the error output signal 114 from the phase detector 101 was considered to be generated from the phase error of the two input signals and the gain of the phase detector 101 was considered to have a unit of Volt/rad. It seems making perfect sense that the phase detector 101 which produces an error output signal 114 with an amplitude proportional to the phase error of the input signals to have a gain with the unit of Volt/rad because error output voltage (Volt)=phase error (rad)*phase detector gain (Volt/rad). But as was explained in great detail in the PCT1US2005/026842, the phase detector is actually a special kind of arrival-time detector and the arrival-time of the signal is determined by the amplitude, frequency and phase of the signal, not just only the phase.

When a steady incoming signal arriving at the receiving end at a predictable time interval suddenly moved in time and arrived at the receiving end at an unexpected time, there is really no way for the receiving end of the signal to be sure about what had changed in the signal transmission process to cause the incoming signal to move in time. The change of phase of the incoming signal could cause the signal to move in time, so could the change of frequency and the change of amplitude. The only thing that is certain at the receiving end of the signal is that the arrival-time of the signal has changed. The concept of phase detector 101 is simply misleading. The behavior of the phase detector 101 should be analyzed with the concept of arrival-time instead and the phase detector's gain should simply have the unit of Volt and the amplitude of the error output signal 114 from the phase detector 101 should be determined by the arrival-time difference between the two input signals.

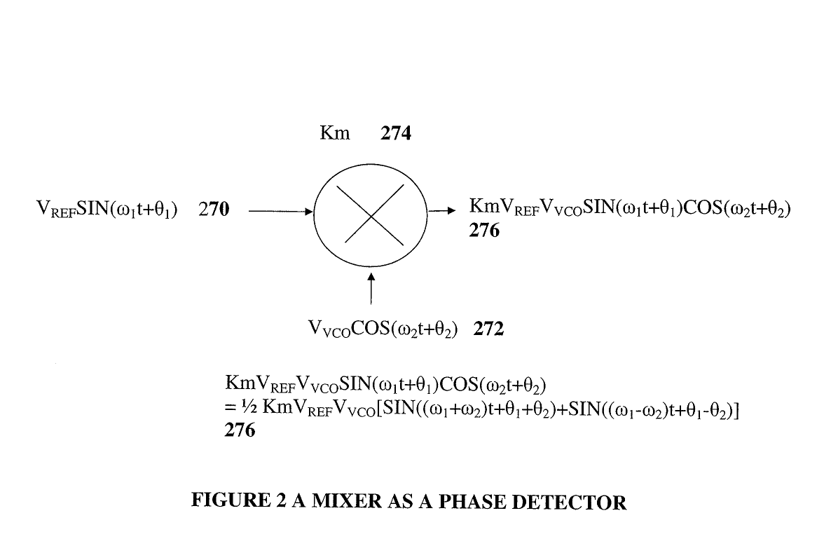

The phase detector 101 definition problem started long ago. In the early days, the most common phase detector used in the analog PLL was a multiplier, such as a frequency mixer, that produces an output voltage which is the multiplication product of the two input signals. The result of the multiplication operation is a voltage that is the function of the amplitude, frequency and phase of the two input signals and should carry Volt as the unit. For example, it is very common to build an analog PLL by using a frequency mixer as the phase detector 101 as shown in FIG. 2. Suppose the two input signals to the phase detector are V_{ref}*SIN (ω₁t+θ₁) 270 and V_{VCO}*COS (ω₂t+θ₂) 272 and the mixer's gain is Kₘ 274, then the output of the mixer will be ½*Kₘ*V_{ref}*V_{vco}*[SIN ((ω₁+ω₂)t+θ₁+θ₂)+SIN ((ω₁−ω₂)t+θ₁−θ₂)]. Since the first SIN term will be filtered out by the loop filter so that the second SIN term will be the only signal reaches the VCO. So the final error correction voltage to the VCO 115 from the mixer's output can be simplified to:

K_{d}=½*Kₘ*V_{ref}*V_{vco}*SIN ((ω₁−ω₂)t+θ₁−θ₂) equ. 1

And both K_{d}, the phase detector's output , and ½*Kₘ*V_{ref}*V_{vco}, which is defined as the gain of the phase detector 101, have the unit of Volts while the last term SIN ((ω₁−ω₂)t+θ₁−θ₂) is a constant and is dimensionless. In the traditional analysis, the frequency ω₁ and ω₂ are assumed to be equal when the loop is in locked condition so that the equation 1 can be further simplified to

K_{d}=½*Kₘ*V_{ref}*V_{vco}*SIN (θ₁−θ₂) equ. 2

And the phase error will be small when the loop is locked so that the equation 2 can be simplified even further to

K_{d}=½*Kₘ*V_{ref}*V_{vco}*(θ₁−θ₂) equ. 3

The above equation 3 is a result of many steps of simplification and since θ₁−θ₂ is the phase error and has the unit of radiant so that in order for the K_{d} to still carry the unit of Volts, the gain of the phase detector must now carry the unit of Volt/rad even though it was defined as Volt in the beginning. It is thus clear that in order to force the concept of the “phase detector” to be accepted, the phase detector's gain is forced to carry the unit of Volt/rad despite the fact that it actually has nothing to do with the phase of the signal directly.

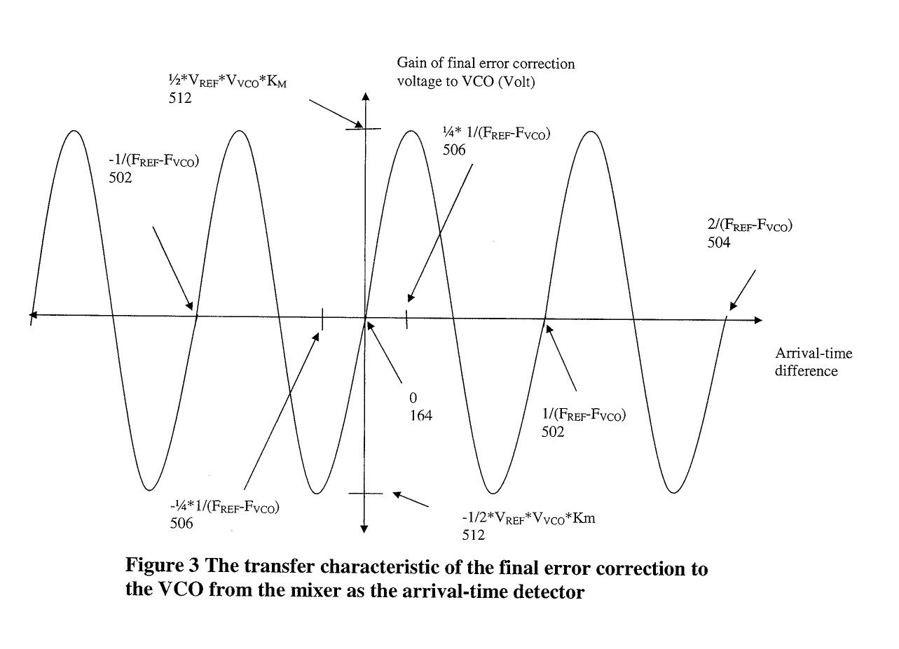

Equation 1 truly describes the multiplication operation of the frequency mixer and characterizes the final error correction voltage output from the frequency mixer to the VCO 115 of the PLL. The equation 1 shows that the final error correction voltage to the VCO 115 from the mixer is the function of the amplitude, frequency and phase of the two input signals so that the mixer is truly an arrival-time detector instead of a phase detector and the analog PLL is actually an analog arrival-time locked loop. We can plot the equation 1 as in the FIG. 3 and it shows the characteristics of the mixer as the arrival-time detector. In order to simplify the drawing, we assume that the two input signals have no phase offset in FIG. 3. When the analog PLL was first developed eighty years ago, it was used primarily in the radio communications. In this application, an Automatic Gain Control (AGC) circuit and an Automatic Frequency Control (AFC) circuit were also used to regulate the amplitude and frequency of the signal. Only when both the amplitude and frequency of the signal were regulated, then the analog PLL had a chance to lock in the phase. Since both the AGC and AFC were feedback control loops with narrow bandwidth, they were unable to prevent the high frequency amplitude noises and frequency noises from reaching the analog PLL circuit. And once the high frequency amplitude noises and frequency noises reached the analog PLL, they all became the phase noises because the mixer of the analog PLL was unable to identify the source of the noises. All the amplitude and frequency noises looked the same as the phase noises to the mixer. This is exactly what the equation 1 is telling us.

As shown in FIG. 3, the mixer as an arrival-time detector has many stable operating points at different arrival-time differences determined by the frequencies of beat signal. Since the desired operating point at the zero arrival-time difference 164 can only be achieved when the frequency of beat signal is small, the analog arrival-time locked loop using mixer as the arrival-time detector has a very small arrival-time capture range that is equal to +/−¼ of the period of the beat signal at most. As we will see later that the actual arrival-time capture range is slightly less than that. For example, if the frequency of the beat signal between a 1 Mhz reference signal and the signal from VCO is 1 Khz, then the arrival-time capture range of the mixer is slightly less than +/−0.25 msec. The mixer can help the VCO capturing the 1 Mhz reference signal easily since the two signals will never arrive at the mixer's inputs apart from each other farther than 1 usec away which is well within the arrival-time capture range. But if the frequency of the beat signal is now 250 Khz and the capture range of the arrival-time difference becomes less than +/−1 usec, then it will be a problem for the mixer now since the two signals can be apart at 1 usec and the loop will not be able to capture the 1 Mhz reference signal.

Amazingly, the concept of arrival-time greatly simplifies the calculation for the capture range for the analog arrival-time locked loop. The concept of arrival-time is relatively new and it only became popular in the late 70 in the field of statistical communications. The concept of arrival-time was born 40 years after the first PLL was developed and it is not a surprise that this new concept can help us solving many impossible problems we faced in the traditional PLL. Before we use the concept of arrival-time to analyze the feedback control loop further, we need to clearly define the gain of the system first.

The gain of a system is defined as the derivative of the output with respect to the derivative of the input. To find out the gain of the feedback control loop, we need to change the input stimulus by a certain amount and measure the changes happened to the output due to the controlled input change and calculate the gain as the change of the output divided by the change of the input. For a feedback control loop systems such as the arrival-time locked loop 100 or PLL 105, the final error correction voltage to the VCO 115 is the output we need to study and the arrival-time difference between the two input signals to the arrival-time detector 104 or phase detector 101 is the controlled input stimulus. The final error correction voltage to the VCO 115 determines how the VCO will respond under a certain input stimulus and the behavior of the final error correction voltage to VCO 115 reflects the same behavior of the whole feedback control loop.

The arrival-time difference signal between the reference signal 110 and the signal from VCO 112 is used as the input stimulus for the analysis of the feedback control loop systems in this disclosure. This new method of using the difference signal as the input signal to the feedback control loop system is completely contrary to the method of traditional feedback control theory. In the traditional feedback control theory, the arrival-time difference between the reference signal 110 and the signal from VCO 112 is considered as one of the output signal and the reference signal 110 is the only input signal to the feedback control loop system. But in fact, the reference signal 110 should not be the input signal to the feedback control loop because it is not part of the feedback loop while the difference signal is. The difference signal should be the only input signal to the feedback control loop system. The reference input signal 110 is only a branch input to a node of the feedback control loop system but is not part of the feedback loop.

One basic rule for the gain of the feedback control loop is that the gain must be non-negative all the time if we use only positive logic to describe the feedback control loop system. A negative gain means that the output is going into the wrong direction and the loop will never converge successfully. Taking the traditional PLL 105 as an example, when the signal from VCO 112 is falling behind the reference signal 110, the arrival-time difference between the two input signals will increase and so will the final error correction voltage to the VCO 115. The frequency of the signal from VCO 112 will then be sped up to reduce the arrival-time difference. The feedback mechanism of the PLL 105 will keep the VCO signal from falling behind and the signal from VCO 112 will be in sync with the reference signal 110 all the time. If the gain of the PLL 105 becomes negative, then the final error correction voltage to the VCO 115 will be decreasing, instead of increasing, when the signal from VCO 112 is falling behind. So the frequency of the signal from VCO 112 will slow down even further and the signal from VCO 112 will never catch up with the reference signal 110. So it is quite obvious that the rule of non-negative gain is the fundamental necessary requirement for a feedback control loop to work properly.

The second rule for the gain of the feedback control loop is that the gain of the loop determines how responsive the loop is and the gain of the loop must be higher than a certain minimum requirement in order to provide capturing ability. Without an adequate gain, the feedback control loop simply does not have the strength to acquire the signals. Taking the traditional PLL 105 as an example again and assuming the PLL 105 is already in the locked condition, if the reference signal 110 starts to speed up in frequency toward a higher frequency so that the VCO signal is falling behind and the final error correction voltage to the VCO 115 is pumping up the frequency of the signal from VCO 112, if the rate to pump up the frequency of the signal from VCO 112 is slower than the rate the reference signal 110 is speeding away, then the PLL will still be unable to track the movement of the reference signal 110. For most systems with a fixed reference signal, the gain is still needed for the PLL 105 to acquire and lock the reference signal quickly during the initial acquisition period. The gain of the PLL determines how fast the frequency of the signal from VCO 112 can be swept and it also determines the loop's acquisition behavior. When we time the gain of the PLL to the VCO sensitivity, the result is the slew rate of the VCO tuning. The minimum gain of the PLL 105 thus determines the minimum slew rate of the VCO frequency and the minimum slew rate determines how agile the VCO is and eventually how agile and powerful the loop is to track the input reference signal.

The gain of the error detector, however, is defined differently. The gain of the error detector at a certain error input should be defined as the output of error detector with respect to the bias point for the output of the error detector. Typically, the output of the error detector should remain at a certain DC level, ideally at half-way between the voltages of the power supply rails, when the error input is zero. This DC level is then used as the reference bias point for the calculation of the gain of the error detector so that the gain of the error detector can become positive or negative when the error input fluctuates around the zero. Although the error output signal 114 can be produced in two different kinds as either in voltage or in current depending upon the type of output driver used, but since the final error correction output voltage to the VCO 115 is always a voltage, we will use only the voltage for the error output signal 114 regardless of what kind of output driver is used. Since the voltage output driver and current output driver are inter-changeable, the use of voltage to represent both output drivers does not affect the performance of the error detector in any way.

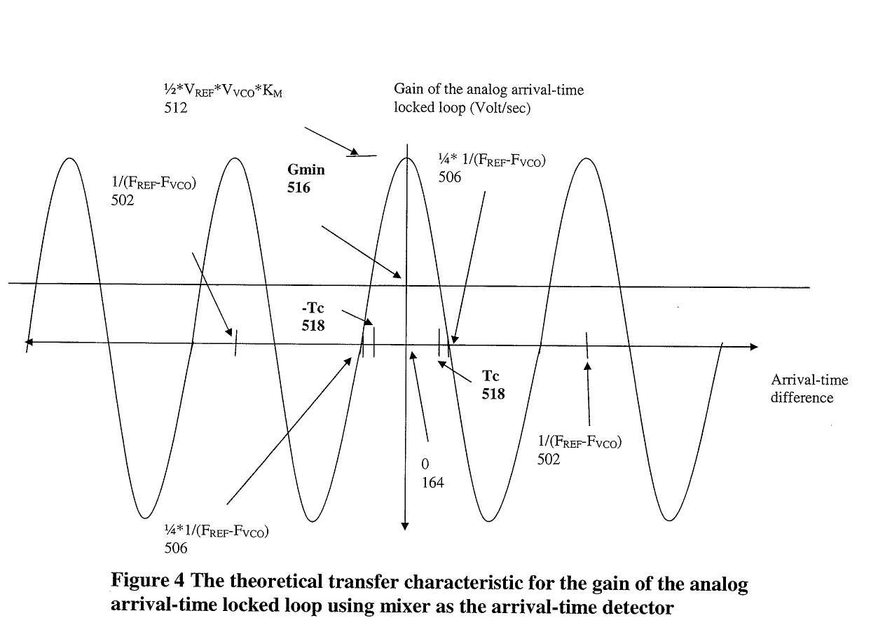

For an analog arrival-time locked loop using the mixer as the arrival-time detector, theoretically, we can find out the gain of the analog arrival-time locked loop by taking the derivative of the final error correction voltage to the VCO 115 as shown in FIG. 3 with respect to the arrival-time difference and plot the gain of the analog arrival-time locked loop using the mixer as the arrival-time detector in FIG. 4. From this figure, it is no surprise to see that the mixer can only work in a certain range of arrival-time difference when the gain is positive. It is quite evident that the mixer as an arrival-time detector has a limited arrival-time capture range of +/−Tc 518 that a minimum gain of Gmin 516 can be delivered to capture the reference signal 110 and has an arrival-time hold range of +/−¼*1/(F_{REF}−F_{VCO}) 506. The hold range of an analog arrival-time locked loop using mixer as the arrival-time detector is the maximum arrival-time difference that can occur to the signals at the inputs of the analog arrival-time loop, which is already in the locked condition, without losing the locked condition. The hold range of an analog arrival-time detector is always larger than the capture range because the analog arrival-time locked loop is already in the locked condition and the analog arrival-time locked loop can remain in the locked condition as long as the gain of the loop is still positive.

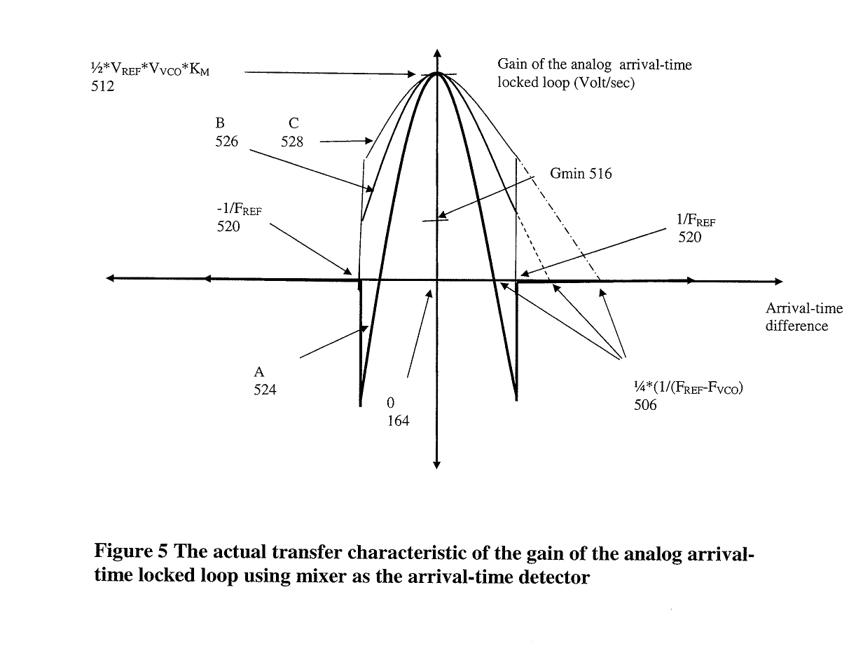

When a mixer is used as the arrival-time detector, the maximum arrival-time difference between the two input signals with two different frequencies is always equal to the period of the faster signal. When one signal is much faster than the other, the faster signal may go through a few cycles before the slower signal arrives again. These extra cycles from the faster signals have no effect to the final error correction voltage to the VCO 115 because they are simply filtered out by the loop filter 106 before getting to the VCO 108. As a result, for a mixer used as the arrival-time detector, the arrival-time difference between the two input signals with different frequencies can't be longer than the period of the faster signal. With this in mind, we will see the FIG. 4 from a completely different prospect. We can plot the actual transfer characteristics of the analog arrival-time locked loop using mixer as the arrival-time detector as in FIG. 5.

In FIG. 5, we limit the range of arrival-time difference to +/−(1/F_{REF}) 520, assuming the reference signal 110 is the faster signal, and copy the gain of the analog arrival-time locked loop using a mixer as the arrival-time detector from the original theoretical transfer characteristics in FIG. 4 between the arrival-time difference of +/−1/(F_{REF}) 520. We are only interested in a small range of the arrival-time difference between +/−1/(F_{REF}) 520 because it is the only range of the arrival-time difference that the mixer as the arrival-time detector can work. Although the mixer can also lock the loop at many other different arrival-time difference points, these points are undesired operating points and we can simply ignore them. As a result, the capture range of frequency of the analog arrival-time locked loop using mixer as the arrival-time detector can be calculated from

½*Km*Vref*Vvco*COS (2π*(Fred−Fvco)/(Fref)>Gmin for Fvco<Fref equ.4

½*Km*Vref*Vvco*COS (2*π*(Fref−Fvco)/Fvco)>Gmin for Fvco>Fref equ. 5

where Gmin 516 is the minimum loop gain needed and Gmin*Kvco is the minimum slew rate of the VCO that the loop can control. So what is the minimum Gmin 516 required? It all depends upon how fast the frequency of the input signals can change. For example, when a system is powered up, the VCO will start to oscillate at one frequency, and the frequency of the VCO will then sweep through some frequencies and it can take some times until the frequency of VCO is stabilized at another frequency. In this period, the frequency of VCO is slewed at a fast rate. If the arrival-time locked loop can't slew as fast as the initial power up VCO slewing condition, then there is no hope that the arrival-time locked loop will be able to track and lock the VCO signal. For an arrival-time locked loop 100 to work properly, the minimum slew rate the loop can deliver to the VCO 108 must be higher than the maximum slew rate of the signals that can possibly occur at the inputs of the arrival-time detector.

Since the frequency of the beat signal can vary during the acquisition period before the arrival-time locked loop is in locked condition, we can imagine that the beat signal is just like an accordion that can be stretched in width while the input signal with a faster frequency is an object with fixed width. The mixer as an arrival-time detector can only work when the period of the faster frequency is well within the first beat signal so that the gain of the mixer is well above 0 all the time. As shown in FIG. 5, the frequency of beat signal as shown in curve A 524, is simply too high for the mixer and negative gains are produced so that the mixer will not be able to acquire and lock the signals. The frequency of the beat signal just meets the minimum gain requirement in curve B 526 and the frequency of the beat signal in the curve C 528 is very low so that the arrival-time locked loop has more than sufficient gain to capture the reference signal.

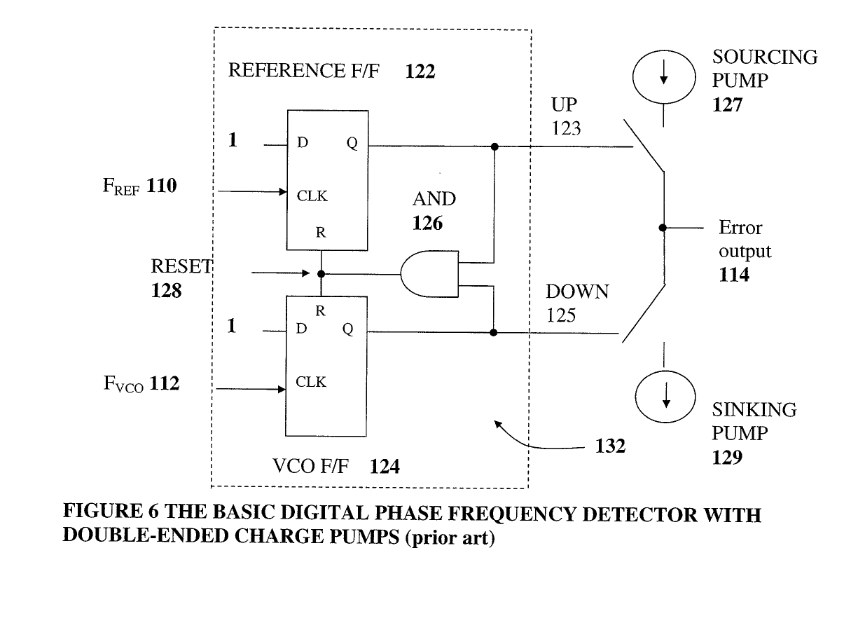

The traditional analog PLL 105 has many drawbacks; first of all, the linear phase detector 101 is an analog device so that it is difficult to be implemented inside an IC, secondly, the linear phase detector can be operated at many stable operating points of different arrival-time difference other than the zero arrival-time difference point 164 as shown in FIG. 4, as a result, the analog PLL system 105 can be locked in a wrong frequency easily and thirdly, the linear phase detector 101 has a very limited capture range as shown in FIG. 5. To overcome these problems, a digital phase detector, commonly known as phase-frequency detector (PFD) was invented. The PFD 132 is a digital device with two flip-flops and an AND logic gate as shown in FIG. 6.

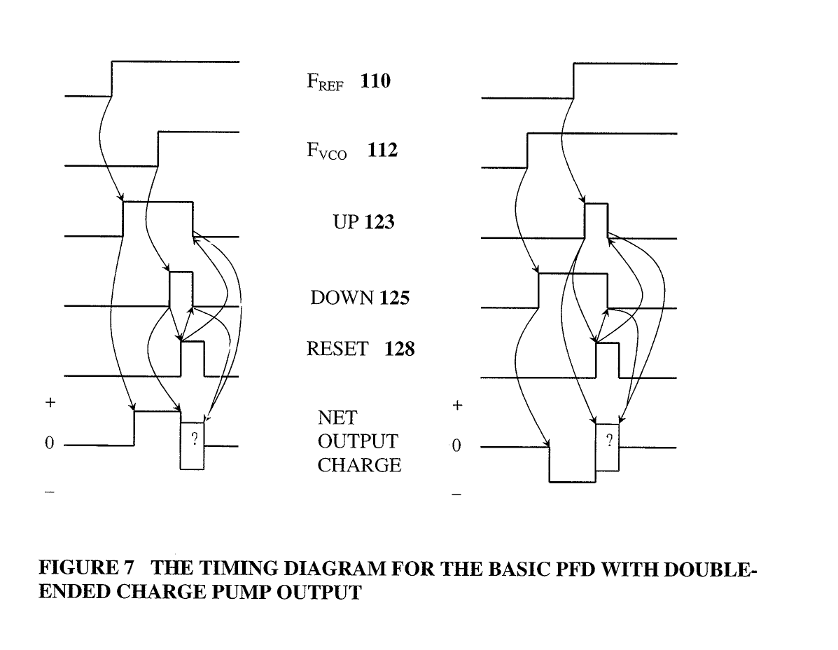

The PFD 132 can be built easily inside an IC and it has only one stable operating point. As a result, it becomes the most popular phase detector today. A typical PFD 132, driving a double-ended charge pump as shown in FIG. 6, is one of the most popular circuits used in every electronic system today. The PFD 132 is normally used to produce an UP output 123 signal to enable a sourcing charge pump 127 and a DOWN output 125 signal to enable a sinking charge pump 129 to generate an error output signal 114 for the loop filter 106 to produce the final error correction voltage 115 for the VCO 108. The timing diagram for the PFD 132 driving a double-ended charge pump is shown as in FIG. 7.

When the signal from VCO 112 arrives first, the DOWN output signal 125 will be active first to discharge the loop filter 106 to reduce the final error correction voltage 115 to slow down the frequency of VCO 108 and the discharging will be stopped shortly after the reference signal 110 finally arrives. When the reference signal 110 arrives first, the UP output signal 123 will be active first to charge up the loop filter 106 to increase the final error correction voltage 115 to speed up the frequency of VCO 108 and the charging will be stopped shortly after the signal from VCO 112 finally arrives. As a result, the amount of final error correction output to the VCO 115 depends totally on the arrival-time difference between the two input signals. The larger the arrival-time difference between the two input signals, the more the frequency of VCO 108 will be corrected so that the PFD 132 with a double-ended charge pump output is truly an arrival-time detector.

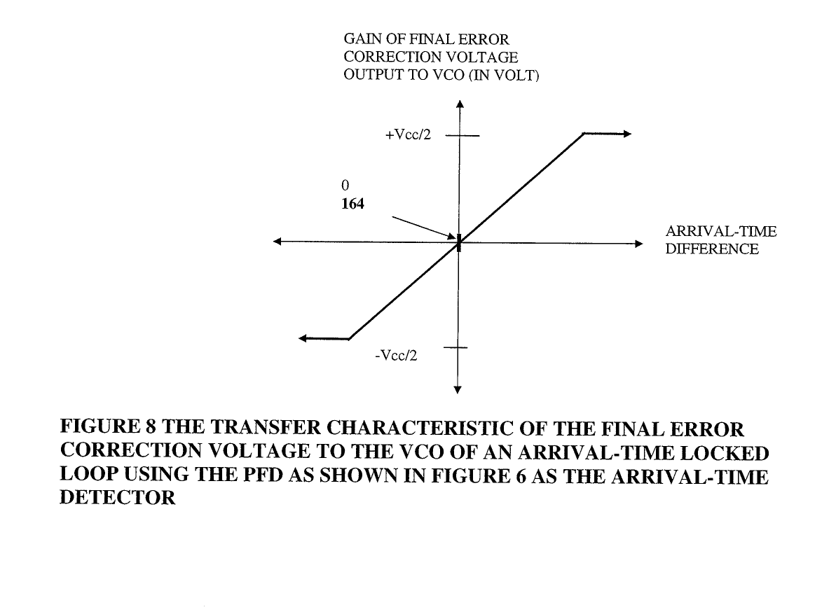

Although the PFD 132 driving a double-ended charge pump output is made of digital devices, its behavior inside the loop is linear because it produces an analog final error correction output signal to the VCO 115 and the amplitude of the final error correction output signal to the VCO 115 is produced linearly according to the difference of the arrival-time between the two input signals. When the two input signals arrive at the same time, the PFD 132 with double-ended charge pump output should produce no output and the final error correction output voltage to the VCO 115 should be biased at ideally Vcc/2. When the arrival-time difference starts to increase or decrease, the final error correction output voltage to the VCO 115 should also increase or decrease accordingly until the final error correction voltage to the VCO 115 reaches the rails of the power supply as shown in FIG. 8. The PFD 132 with a double-ended charge pump output is thus an arrival-time detector instead of the phase detector since the polarity and amplitude of the final error correction output to the VCO 115 is determined by the arrival-time difference between the two input signals instead of the phase.

Unfortunately, the output from the double-ended charge pump output driver driven by the PFD 132 is inevitably contaminated by a glitch as shown in the timing diagram for the PFD in FIG. 7. This is because although the PFD 132 generates two output signals, UP 123 and DOWN 125, only either one of the output signals carries the difference of arrival-time information at any given time. For example, when the reference signal 110 is ahead of the signal from VCO 112, only the UP output 123 contains the information of the difference of arrival-time between the two input signals and when the signal from VCO 112 is ahead, only the DOWN output 125 carries the information of the difference of arrival-time between the two input signals. As a result, we depend upon the output charge pumps 127 and 129 to generate the error output signal 114 containing only the desired arrival-time difference information regardless of which signal is ahead.

The charge pumps 127 and 129 are now a part of the decision circuit for the arrival-time detection and unfortunately, both of the UP 123 and DOWN 125 outputs will be inevitably active at the same time during the reset period of the flip-flops regardless of which signal is leading. Ideally, both of the sourcing charge pump 127 and sinking charge pump 129 should pump out or sink in the same amount of current for the same amount of time during the reset period of the flip-flops so that the net output charges pumped to the loop filter 106 during the reset period of the flip-flops is zero. But in reality, the charge pumps will pump out or suck in different currents and it is impossible to match the two charge pumps and delay paths perfectly every time, all the time. As a result, the charge pumps still produce some outputs at the zero arrival-time difference point when the two input signals arrive at the same time. The amount of current output at the zero arrival-time point will vary and depend upon the noises of the charge pumps. A discontinuity glitch is thus generated at the output of the arrival-time detector using PFD 132 with a double-ended charge pump output driver at the zero arrival-time difference point 164 as shown in FIG. 8. The discontinuity glitch is generated because the double-ended charge pumps are part of the decision making circuit and it is impossible to balance the two charge pumps perfectly all the time, every time. To solve the discontinuity glitch problem, we need to remove the double-ended charge pumps from the decision making circuit so that the charge pumps are simply output drivers, the way they are supposed to be.

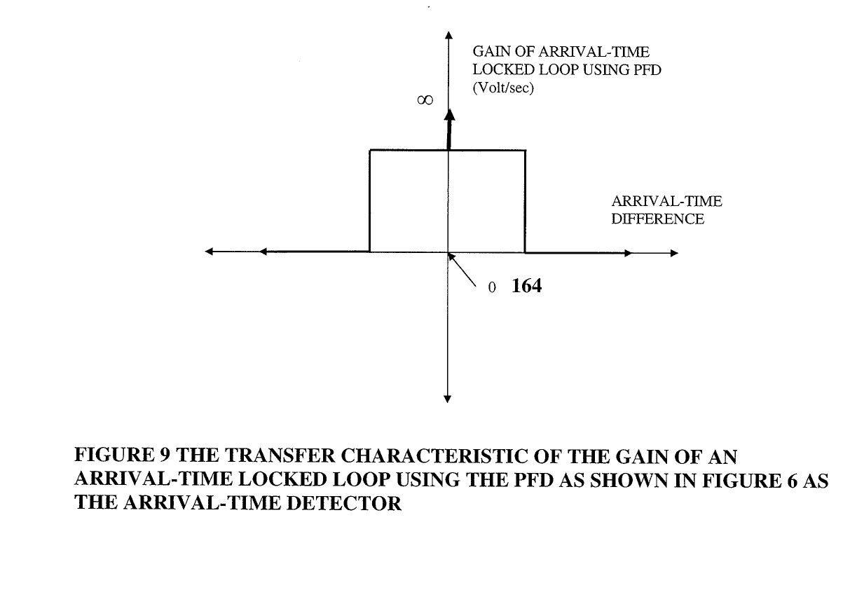

The discontinuity glitch, regardless how small it is, will cause a problem for the arrival-time locked loop using PFD 132 with double-ended charge pump as the arrival-time detector when both signals arrive at the same time because this discontinuity glitch becomes a singularity glitch for the arrival-time locked loop. The gain of the arrival-time loop using PFD with double-ended charge pump output becomes infinite at the point of zero arrival-time difference 164 because the double-ended charge pumps output driver produces an output from nothing. The gain of arrival-time locked loop using PFD with double-ended charge pump output can be plotted as shown in FIG. 9 by taking the derivative of the final error correction voltage to the VCO 115 as shown in FIG. 8 with respect to the arrival-time difference. The discontinuity glitch of the transfer characteristic at the point of zero arrival-time difference 164 as shown in FIG. 8 will generate a jitter to the VCO 108 because the discontinuity glitch of the final error correction voltage to the VCO 115 becomes a singularity glitch for the arrival-time locked loop and the singularity glitch contains energy in the whole frequency spectrum that can not be filtered out completely by the loop filter 106.

The effect of discontinuity glitch at the zero arrival-time difference point 164 is very different than the error caused by the delay mismatch of the flip-flops in the PFD or leakage current of the loop filter 106. The delay mismatch will only shift the transfer characteristic of the arrival-time detector horizontally while the leakage current of the loop filter will only shift the transfer characteristic vertically without generating any discontinuity. In a conclusion, the PFD 132 driving a double-ended charge pump output is a special kind of digital arrival-time detector with the presence of a singularity.

We just can't use the PFD 132 with a double-ended charge pump as the digital arrival-time detector for an arrival-time locked loop because it is incapable of doing so without generating a glitch. The PFD 132 is simply a device to tell us which signal is ahead and which signal is behind, no more and no less. As mentioned before, when the reference signal 110 is ahead, only the UP output 123 contains the arrival-time difference information and the DOWN output 125 contains only the timing information of late arrival signal from VCO112 while when the signal from VCO 112 is ahead, only the DOWN output 125 contains the arrival-time difference information and the UP output 123 contains only the timing of the late arrival reference signal 110. This is the only thing the PFD 132 can do, to tell us which signal is ahead and which signal is behind without ambiguity and metastability problem.

### New Design of Arrival-time Locked Loop Using Digital Arrival-time Detector

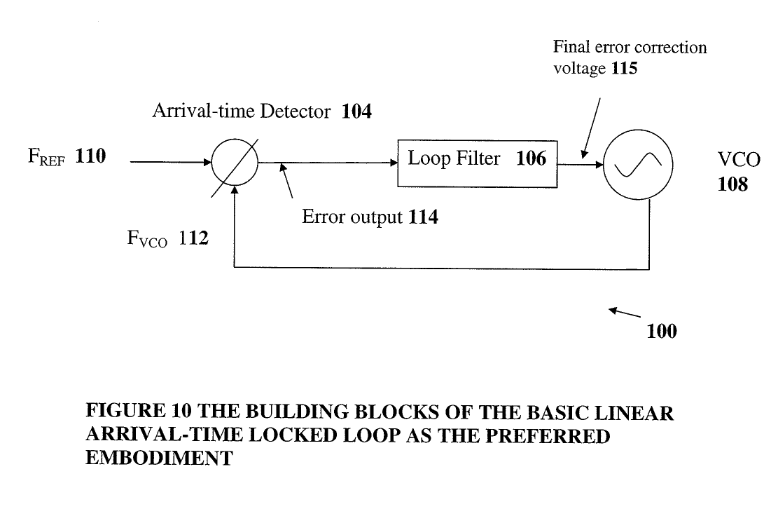

The block diagram of a basic linear arrival-time locked loop 100 system generating a stable VCO output signal 112 with the frequency and phase equal to the frequency and phase of the reference input signal 110 is as shown in FIG. 10 as the preferred embodiment. The basic linear arrival-time locked loop system 100 includes three functioning blocks, the arrival-time detector 104, the loop filter 106 and the VCO 108. The arrival-time detector 104 compares the arrival-time of the reference signal 110 with the arrival-time of the signal from VCO 112. The arrival-time detector 104 then sends out an error output signal 114 to correct the frequency of VCO 108. The error output signal 114 is filtered by the loop filter 106 first and then it becomes the final error correction voltage 115 to the VCO 108. If the reference signal 110 is ahead of the signal from VCO 112, a positive error output signal 114 is sent out to speed up the frequency of VCO 108. If the reference signal 110 is behind of the signal from VCO 112, then a negative error output signal 114 is sent out to slow down the frequency of VCO 108. As a result, the basic linear arrival-time locked loop 100 produces a stable output signal 112 with the frequency and phase equal to the frequency and phase of the reference signal 110 just like a typical PLL 105.

Theoretically, there are two ways to make an arrival-time detector 104 for the linear arrival-time locked loop 100. One way is to use a linear device that generates an error output signal 114 whose polarity is determined by which input signal has arrived first and whose amplitude is produced linearly according to the arrival-time difference between the two input signals. Unfortunately, a linear device like this has not been invented yet. The other way is to use digital devices. We can use a digital device to generate a polarity output for the arrival-time difference to tell us which signal arrives first and we can generate a digital error output signal with the width of the output signal produced linearly according to the arrival-time difference between the two input signals. We can then integrate the digital error output signal and the output voltage at the end of integration will be determined by the arrival-time difference between the two input signals. In a conclusion, we need a digital device to determine the polarity of the arrival-time difference and another digital device to generate a pulse with the pulse width determined by the arrival-time difference between the two input signals. With these two digital devices and an integrator, we can generate a linear final error correction output voltage 115 accurately and precisely from the arrival-time difference between the two input signals to control the VCO.

All the phase detectors or phase-frequency detectors used nowadays are capable of fulfilling the functions of the above two digital devices to some extends. However, as the two examples illustrated earlier, none of them can produce the final error correction output voltage 115 to the VCO without error so far. The analog phase detector has many undesired stable operating points at different arrival-time differences and the current PFD 132 with double-ended charge pump output generates an erroneous glitch. As a result, a true arrival-time detector 104 that has only one stable operating point without generating any undesired glitch has not yet been invented before and the arrival-time locked loop 100 has not yet been developed until now.

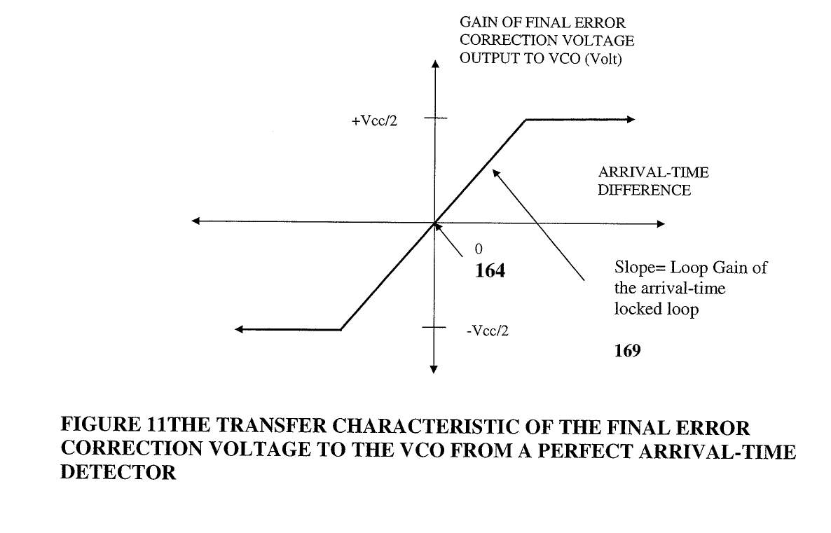

An ideal arrival-time detector 104 should produce a final error correction output voltage 115 to control the VCO as shown in FIG. 11 so that the loop gain 169 of the arrival-time locked loop 100 is a positive constant. The PFD 132 with a double-ended charge pump output is almost an ideal arrival-time detector only if the discontinuity glitch is removed. The discontinuity glitch problem of the PFD 132 with a double-ended charge pump output is commonly known as the “dead zone jittering problem”. There are many inventions offering solutions to solve the “dead zone jittering problem” for the current PFD 132 with a double-ended charge pump output but none of them can truly solve the problem. Most solutions simply add more delay to the reset signal of the flip-flops so that the magnitude of the glitch will be larger and the PFD 132 will be operated with a larger phase offset and the jittering problem will become less obvious because the PFD 132 will be operated farther away from the zero arrival-time difference point 164 that generates glitch. But the fundamental glitch problem is not fixed. The solution proposed by U.S. Pat. No. 6,157,218 offers a design without dead-zone jittering problem by preventing both the charge pumps of the PFD from being ON at the same time. It was a clever design in the right direction but this design apparently failed to prevent both UP 123 and DOWN 125 output from being turned ON at the same time when both input signals arrive at the same time because there is a long feedback delay before the flip-flops can be turned OFF. This solution is actually the same as most others and the reason it seemed to have effectively solved the dead zone jittering problem is the fact that it provided a longer reset delay to the flip-flops to operate the PFD 132 away from the zero arrival-time difference point 164. The only unique design of the PFD that can deal with the dead zone jittering problem effectively is from ROHM that provided a design of PFD with a large dead-zone, wider than the slew time of the charge pump output driver, to prevent the jittering problem. As shown in their data sheet for BU2374FV, a large dead zone is used to stop the charge pumps from working when the arrival-time difference is less than the slew time of the charge pump output driver. As a result, the output from their PFD has only three stable output states the H, L and OFF state. Although it can effectively prevent the glitch from happening but the PFD is inactive most of the time in their design and the PLL will not be able to correct the phase error precisely so the phase noise will be high. Their PFD is simply disabled most of the time and the frequency of VCO is allowed to wonder in a large uncertainty window before being corrected.

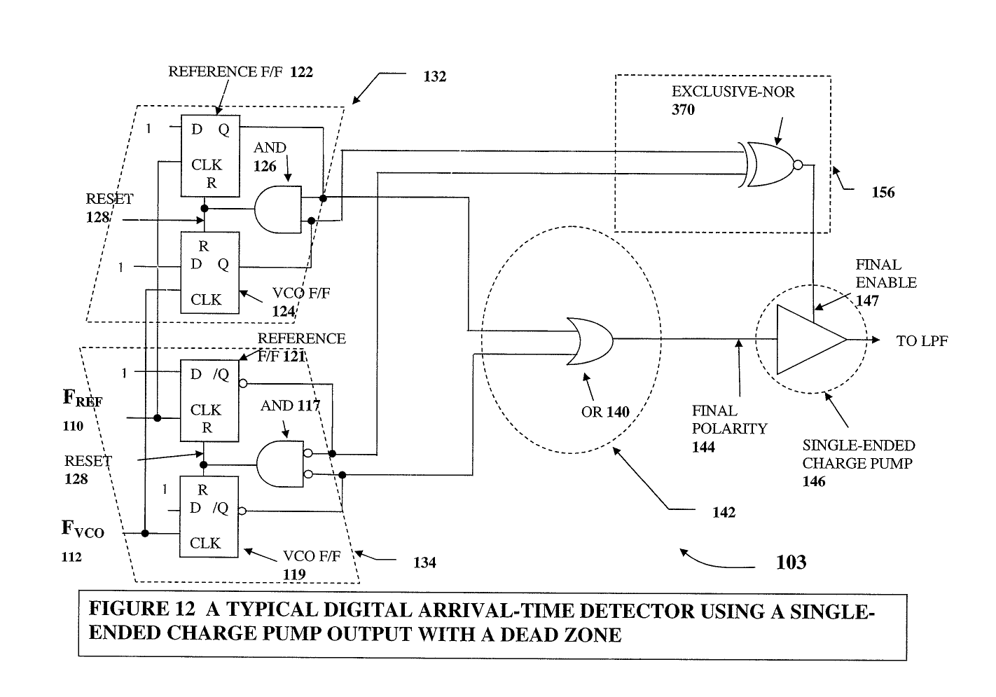

A true solution to the glitch problem was finally presented in the PCT/US2005/026842 filed on Jul. 28, 2005, “A system, method and circuit to detect a phase, a frequency and an arrival-time difference between two signals.” By Wen T. Lin. This patent disclosure illustrated many ways to build a precise arrival-time detector with single-ended charge pump output driver as shown in FIGS. 12, 13 and 14.

In order to differentiate the arrival-time detectors 104 for the discussions in rest of this disclosure, we will classify the arrival-time detectors 104 in three categories, the analog arrival-time detector, the erroneous digital arrival-time detector and the digital arrival-time detector. The mixer belongs to the category of the analog arrival-time detector and the PFD 132 with double-ended charge pump output belongs to category of the erroneous digital arrival-time detector. All the current designs of phase detector or phase frequency detector belong to either the first or the second kind of the arrival-time detectors. All the new precise, error-free, arrival-time detectors belongs to the category of digital arrival-time detectors 116.

In all the designs of new digital arrival-time detectors with single-ended charge pump output as shown in FIGS. 12, 13 and 14 include five circuit modules, a PFD 132, a complementary PFD 134, a polarity decision circuit 142, an enable signal selection circuit 156 and a single-ended charge pump output driver 146. The single-ended charge pump output driver 146 can either only pump out current or sink in current at any given time so that it will never generate the same glitch that occurs to the PFD 132 with double-ended charge pump output, if the single-ended charge pump output driver 146 is designed correctly.

In the design shown in FIG. 12, a single OR gate 140 is used as the polarity decision circuit 142 so that the final polarity output 144 of the polarity decision circuit 142 is H by default before the signals arrive. If the signal from VCO 112 arrives earlier, the final polarity signal 144 will be L and it will return to H when the reference signal 110 finally arrives. If the reference signal 110 arrives earlier, then the final polarity signal 144 will remain H all the time. So the final polarity signal output 144 is always accurate. The duration of the final polarity output signal 144 is always at least the same as the arrival-time difference between the two input signals. Since the time period of the final enable signal 147 to enable the single-ended charge pump output driver 146 is always equal to the arrival-time difference between the two input signals, if the timings of the final polarity output signal 144 and the final enable signal 147 are aligned properly, the single-ended charge pump output driver 146 will always produce an error-free output. As a result, the design in FIG. 12 is a precise digital arrival-time detector 103. The digital arrival-time detector 103 can always pump out current or sink in current from the loop filter for a time period exactly equal to the arrival-time difference between the two input signals so that it can produce an accurate final error correction voltage 115 for the VCO linearly according to the arrival-time difference between the two input signals.

The OR logic gate 140 can be replaced by an AND logic gate 141. With an OR logic gate 140, the default state of the final polarity output 144 is H because the default state of the VCO F/F 119 is H. When an AND logic gate 141 is used to replace the OR logic gate 140, the default state of the final polarity output 144 will be L instead but the result of the final polarity output 144 will remain the same.

Two PFDs 132 are needed for all the digital arrival-time detectors 116 to prevent the erroneous glitch that occurred in the traditional PFD 132. This is because that each of the flip-flop output of the PFD 132 can only produce a valid output signal with the desired arrival-time difference information when the clock input to that flip-flop is the leading signal. As a result, we need two PFDs to produce two arrival-time difference signals for each of the two input signals so that the charge pump output driver can be used simply as the charge pump output drivers and the charge pump output driver will not be involved in the generation of the arrival-time difference output and the glitch problem is solved completely. In order to differentiate the two outputs from two PFDs, we need to make one of the PFDs as the complementary PFD 134.

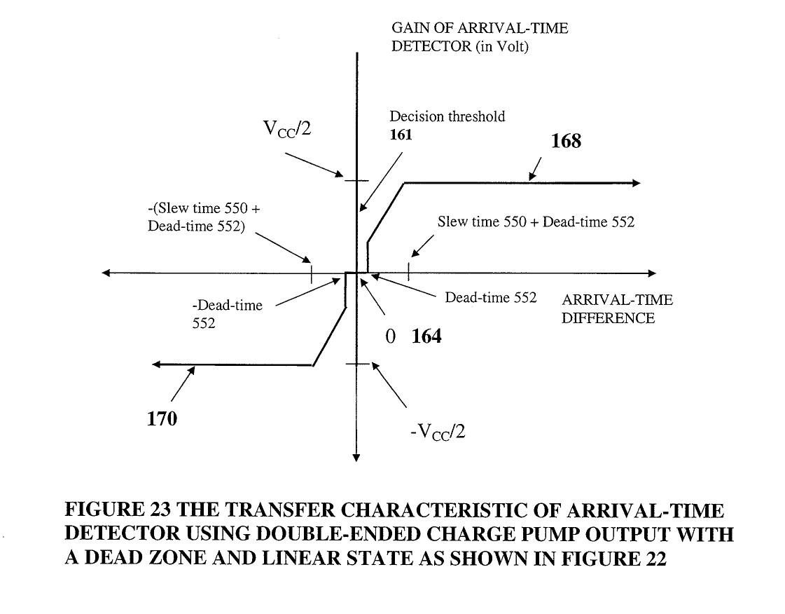

In the design of FIG. 12, the single-ended charge pump output driver 146 is enabled for a time period exactly equal to the arrival-time difference between the two input signals due to the exclusive NOR gate 370 of the enable signal selection circuit 156. Since both input signals can arrive at the same time so that the minimum arrival-time difference between the two input signals is zero and the maximum arrival-time difference between the two input signals is infinity if either one of the input signal is absent. Since it takes time for a digital signal to rise from L to H or to fall from H to L, the digital signal at the input of a logic device needs time to travel across the input threshold of the logic device to cause the logic device to produce an action. When both input signals, 110 and 112, arrive at the same time, the time period of the final enable signal 147 to the single-ended charge pump output driver 146 will have a minimum width of zero so that the single-ended charge pump output driver 146 will never be turned on. The single-ended charge pump output driver 146 will not start to be turned on until the difference of the arrival-time between the two input signals is longer than the dead time 552 which is time needed for the final enable signal 147 to rise above the input threshold of the single-ended charge pump output driver 146. As a result, the single-ended charge pump output driver 146 will remain inactive until the arrival-time difference between the two input signals, 110 and 112, is longer than the dead-time 552 and a dead-zone is unavoidable as shown in FIG. 23. The FIG. 23 is to show the output characteristic of a digital arrival-time detector using double-ended charge pump output driver with a dead zone and linear state and this figure can be also used to show the output characteristic of a digital arrival-time detector using single-ended charge pump output driver with a dead zone and linear state as well.

When the single-ended charge pump output driver 146 starts to be turned on as the time period of the final enable signal 147 starts getting longer than the dead-time 552, the single-ended charge pump output driver 146 will be gradually pumping out or sinking in more and more current until the output current reaches the capacity limit of the single-ended charge pump output driver 146. The time period between when the single-ended charge pump output driver 146 starts to pump out or sink in current until when the single-ended charge pump output driver 146 reaches the capacity limit of output current is called the slew time 550 of the single-ended charge pump output driver 146. When the arrival-time difference between the two input signals is less than the sum of slew time 550 and dead time 552 of the single-ended charge pump output driver 146 but is longer than the dead time 552, the output current of the single-ended charge pump output driver 146 will be produced linearly according to the time period of the final enable signal 147. The output of the single-ended charge pump output driver 146 is said to be in the linear state when the time period of the final enable signal 147 is less than the sum of slew time 550 and dead time 552 but is longer than the dead time 552 of the single-ended charge pump output driver 146.

The dead-zone is an undesired state for the digital arrival-time detector 103 because the digital arrival-time detector 103 in the dead-zone will not be able to produce an error output to correct the frequency of the signal from VCO 112. The linear state of the single-ended charge pump output driver 146 is also an undesired state because the output of the single-ended charge pump output driver 146 is not a constant. To prevent the dead-zone and linear state, we will need to lengthen the time period of final enable signal 147 so that the final enable signal 147 always has a minimum time period longer than zero and the final enable signal 147 will always have the extra time to rise above the dead time 552 of the single-ended charge pump output driver 146 and also last longer than the sum of slew time 550 and dead-time 552 of the single-ended charge pump output driver 146 so that the charge pump output will always be fully turned on regardless of how small the arrival-time difference between the two input signals is. Luckily, a lengthen arrival-time difference signal is ready available from the output of the PFD 132.

As shown in FIG. 7, since the UP output 123 from the reference flip-flop 122 of the PFD 132 has a time period longer than the arrival-time difference when the reference signal 110 arrives earlier due to the propagation delay of the reset signal and the DOWN output 125 from the VCO flip-flop 124 of the PFD 132 has a time period longer than the arrival-time difference when the signal from VCO 112 is leading, if we choose either the UP output 123 from the PFD 132 when the reference signal 110 is ahead or DOWN 125 output signal from another PFD 132 when the signal from VCO 112 is ahead as the final enable signal 147 for the single-ended charge pump output driver 146, then both the dead-zone and linear state at the single-ended charge pump output driver 146 can be eliminated. The time period of the signal at UP output 123 from the reference flip-flop 122 and the DOWN output 125 from the VCO flip-flop is always longer than the arrival-time difference by the amount of four times the propagation delay of a single logic gate which is normally longer than the sum of slew time 550 and dead time 552 of the single-ended charge pump output driver 146 so that the dead-zone and linear state can be eliminated altogether.

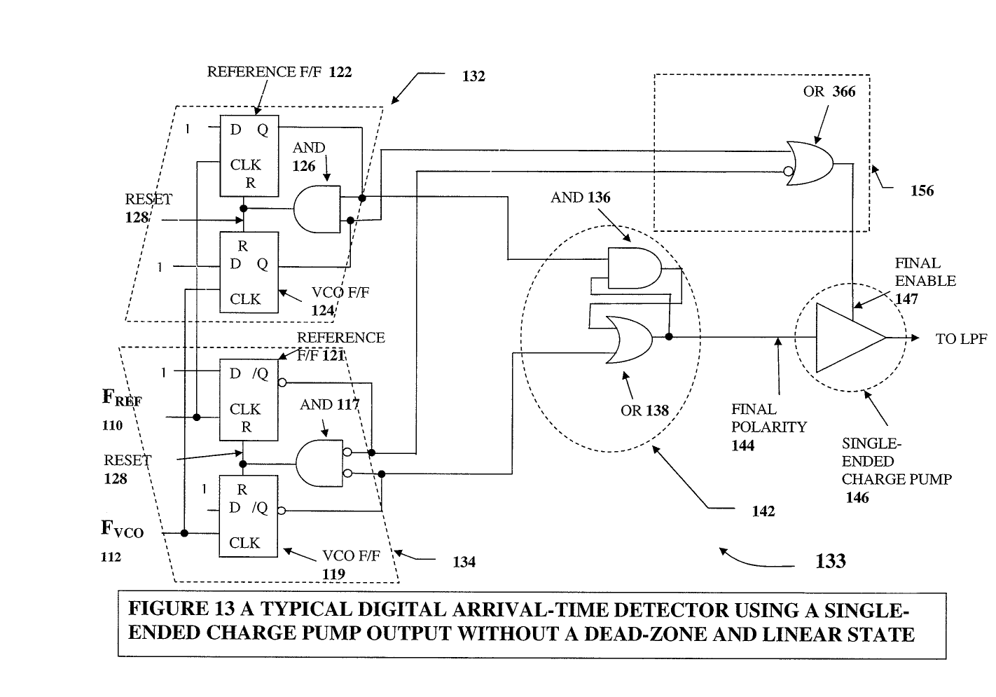

The design as shown in FIG. 13 produces a digital arrival-time detector 133 without the dead-zone and linear state. This digital arrival-time detector 133 will pump out or sink in current from the loop filter for a time period slightly longer than the arrival-time difference between the two input signals so that it produces a final error correction voltage 115 for the VCO linearly according to the arrival-time difference between the two input signals all the time, regardless of how small the arrival-time difference is.

We also need to maintain the same final polarity signal 144 during the entire period when the final enable signal 147 is active so that the width of the final polarity output signal 144 must have at least the same width as the final enable signal 147. To do that, we need to use an AND logic gate 136 and an OR logic gate 138 to lock in the final polarity output 144 so that the final polarity output signal 144 will last as long as the final enable signal 147.

In the design of FIG. 13, when the reference signal 110 is ahead of the signal from the VCO 112, the decision output of AND logic gate 136 will lock the final polarity output 144 of the polarity decision circuit 142 to H and when the signal from VCO 112 is ahead of the reference signal 110, the decision output of OR logic gate 138 will lock the final polarity output 144 of the polarity decision circuit 142 to L until the end of arrival-time comparison cycle when both flip-flops are reset. As a result, the final polarity output 144 indicates which signal has arrived first and it lasts as long as the UP output 123 and DOWN output 125 of the PFDs 132 and the final enable signal 147.

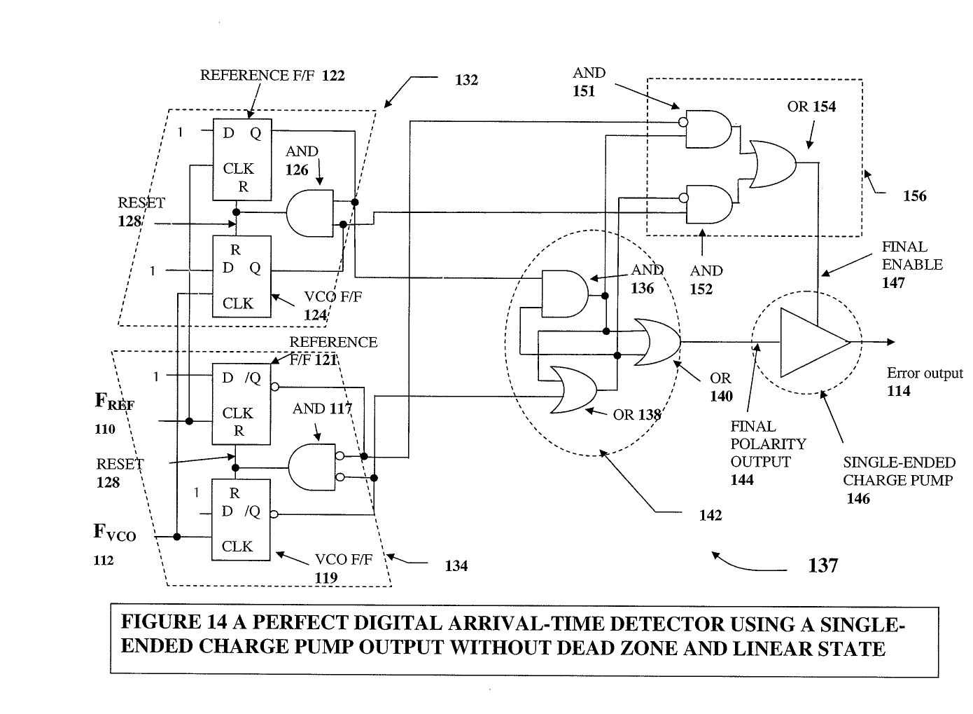

Both the designs as shown in FIGS. 12 and 13 contain only the minimum components needed for a digital arrival-time detector 116. These designs provide the basic arrival-time detection function but at a price. The design in FIG. 13 has a large polarity decision uncertainty window of +/−(propagation delay of a single logic gate) and the design in FIG. 12 requires a close match of the propagation delay for the final enable signal 147 and the final polarity output signal 144 because both signals have exactly the same width as the arrival-time difference between the two input signals. Mismatched timing between these two paths can significantly distort the linearity of the gain of the digital arrival-time detector 103. An optimal design of the digital arrival-time detector 137 that has a smaller decision uncertainty and less critical matching requirement is as shown in FIG. 14. In this design, an OR logic gate 140 is added to the polarity decision module 142 and a switch is added for the enable signal selection circuit 156. The decision uncertainty of the design in FIG. 14 is only +/− 1/2 (propagation delay of a single-logic gate) and since both the final polarity signal 144 and the final enable signal 147 have a much wider width than the arrival-time difference between the two input signals, the matching requirement for the timing between the final enable signal 147 and final polarity signal 144 is more relaxed.

The design as shown in FIG. 14 is thus the most desirable digital arrival-time detector 116 using single-ended charge pump output driver. In this design, the final polarity output 144 of the digital arrival-time detector 137 is determined by the polarity decision circuit 142 which is made of an AND logic gate 136 and an OR logic gate 138. The outputs from these two logic gates are then combined by an OR logic gate 140 to become the final polarity output signal 144. The AND logic gate 136 and OR logic gate 138 lock the polarity decision by using feedback arrangements between these two gates.

When the reference signal 110 is leading, the UP output signal from the output of the reference F/F 122 will turn both the AND logic gate 136 and OR logic gate 138 of the polarity decision circuit 142 into the H state. When the signal from VCO 112 is leading, the DOWN output signal from the output of VCO F/F 119 will turn both the OR logic gate 138 and AND logic gate 136 of the polarity decision circuit 142 into L state.

The feedback arrangement from the output of the AND logic gate 136 to the input of the OR logic gate 138 can lock in the final polarity output 144 to the H state when the reference signal 110 arrives first. The feedback signal blocks the late arrival signal from VCO 112 to prevent it from switching the outputs of the OR logic gate 138, AND logic gate 136 and OR logic gate 140 after they are already turned to the H state by the leading reference signal 110.

The feedback arrangement from the output of OR logic gate 138 to the input of AND logic gate 136 can lock in the final polarity output 144 to the L state when the signal from VCO 112 arrives first. The feedback signal blocks the late arrival reference signal 110 to prevent it from switching the outputs of the OR logic gates 138 and 140 and AND logic gate 136 after they are already turned to the L state by the leading signal from VCO 112.

Since it takes time, which is equal to precisely a propagation delay time of a single logic gate, for the feedback signal to travel from the input of the OR logic gate 138 to the input of the AND logic gate 136, the feedback signal may not be ready to block the late arrival reference signal 110 to prevent it from switching the output of the AND logic gate 136 into the H state when the arrival-time difference between the two input signals is smaller than the propagation delay time of a single logic gate. This can be a problem when the signal from VCO 112 arrives first and the final polarity output 144 at the output of OR logic gate 140 is already in the L state and the late arrival reference signal 110 is still able to turn the final polarity output 144 into the H state. This won't be a problem when the reference signal 110 arrives first and the final polarity output 144 is already in the H state because even if the late arrival signal from VCO 112 turns the output of OR logic gate 138 into the L state, it won't be able to turn the output of the OR logic gate 140 into the L state due to the nature of the OR gate.

As a result, the late arrival reference signal 110 can still turn the final polarity output 144 to the H state after the signal from VCO 112 has turned the final polarity output 144 to the L state when the arrival-time difference is less than the propagation delay time of a single logic gate, however, the erroneous H state is very short lived due to the feedback arrangement. As soon as the output of AND logic gate 136 finally becomes the L state after a propagation delay time of a single logic gate, the output of the OR logic gate 140 will also return to the correct L state shortly after. Since the erroneous H state can pass through the feedback arrangement from the output of AND logic gate 136 back to turn the OR logic gate 138 into the erroneous H state again, the final polarity output 144 will then bounce back and forth between the H state and L state during the entire period of the polarity signal.

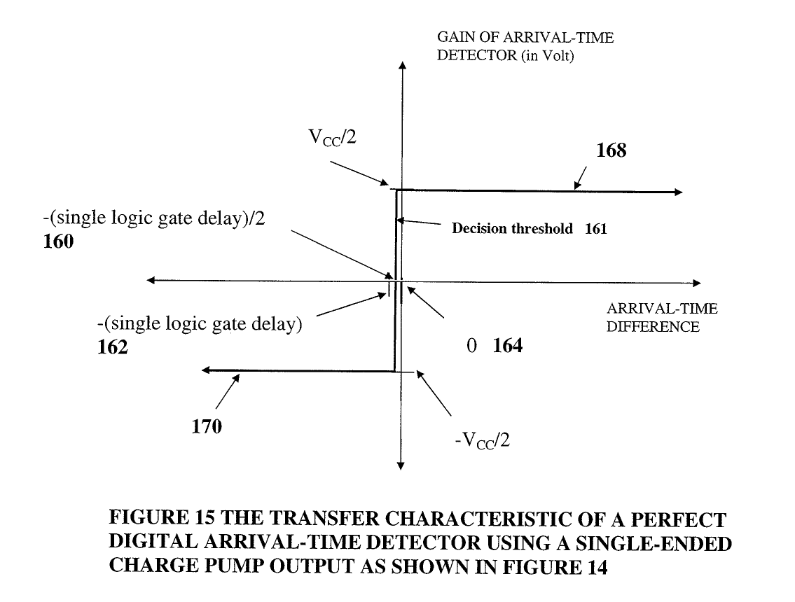

The final polarity output 144 will be H when the reference signal 110 is ahead but when the signal from VCO 112 is ahead, the final polarity output 144 will be L for sure only w h e n the signal from VCO 112 is ahead of the reference signal 110 by at least a propagation delay time of single logic gate 162. The decision of the polarity selection circuit favors the reference signal 110. As a result, the decision threshold 161 is not located at the zero arrival-time difference point 164 but is shifted slightly toward the negative side by the amount of half of the propagation delay time of a single logic gate 160 assuming all the propagation paths are well matched as shown in FIG. 15. When the signal from VCO 112 is leading and the arrival-time difference is within a propagation delay time of a single logic gate 162, as was explained in the above, the final polarity output 144 can bounce between H and L for the entire time period of polarity signal. The duty cycle of the bouncing polarity decision signal is determined by how far the arrival-time difference is to the decision threshold 161. For example, when the signal from VCO 112 is ahead of the reference signal 110 by a propagation delay time of a single logic gate 162, the final polarity output 144 will remain L all the time. If the VCO starts to slow down and the arrival-time difference is moving closer to the decision threshold 161, the bouncing polarity decision will initially stay L most of the time and it will stay H more often as the arrival-time difference is getting closer to the decision threshold 161. When the arrival-time difference reaches the decision threshold 161, the bouncing polarity decision will have a duty cycle of 50%. This makes perfect sense since this is also the point that the polarity decision circuit 142 does not know what to do. When the signal from VCO 112 continues to slow down and the arrival-time difference continues to move away from the decision threshold 161, the bouncing polarity decision will then stay H more often until it remains H all the time when the arrival-time difference becomes positive. When the polarity decision is bouncing, the output of the single-ended charge pump output driver 146 will bounce, too. As a result, the net current sunk in or pumped out of the single-ended charge pump output driver 146 is produced linearly according to the arrival-time difference precisely even around the decision threshold 161 and the decision of the polarity selection is always accurate, precise with no ambiguity. The design of digital arrival-time detector 137 is thus a perfect digital arrival-time detector 116 using a single-ended charge pump output driver except that the decision threshold 161 is not located at the ideal zero arrival-time difference point 164.

The reason that the polarity decision circuit 142 of the digital arrival-time detector 137 favors the reference signal 110 is because of the OR logic gate 140. If the OR logic gate 140 is replaced by an AND logic gate 141, the output of polarity decision circuit 142 will remain L by default and will be turned to H only when the reference signal 110 arrives first. The polarity decision circuit 142 will then favor the signal from VCO 112 and the decision threshold 161 will be shifted slightly to the right by the amount of half of the propagation delay of a single logic gate 160.

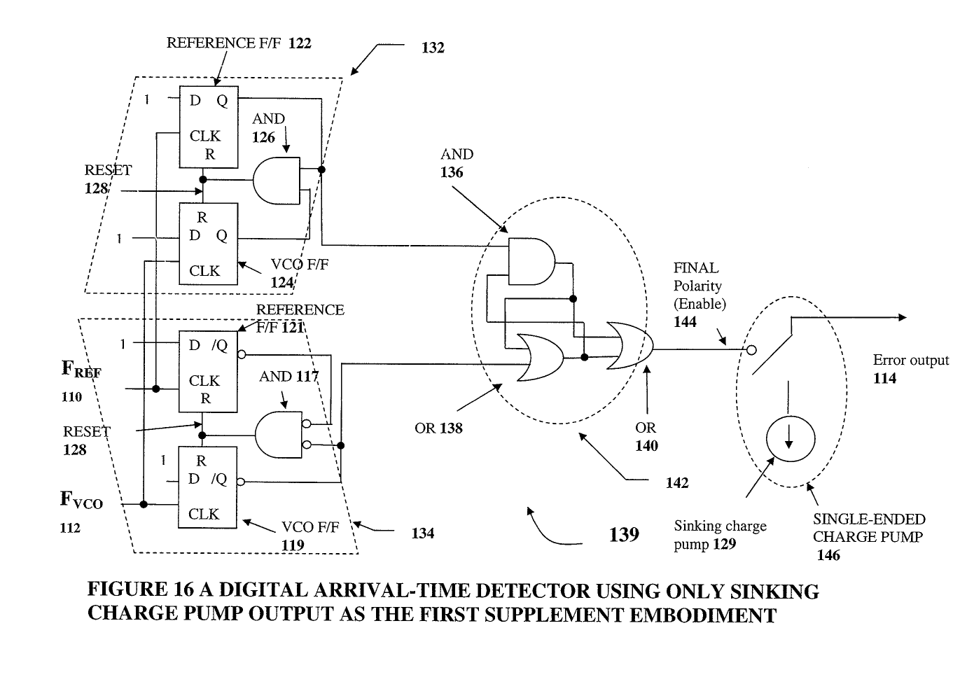

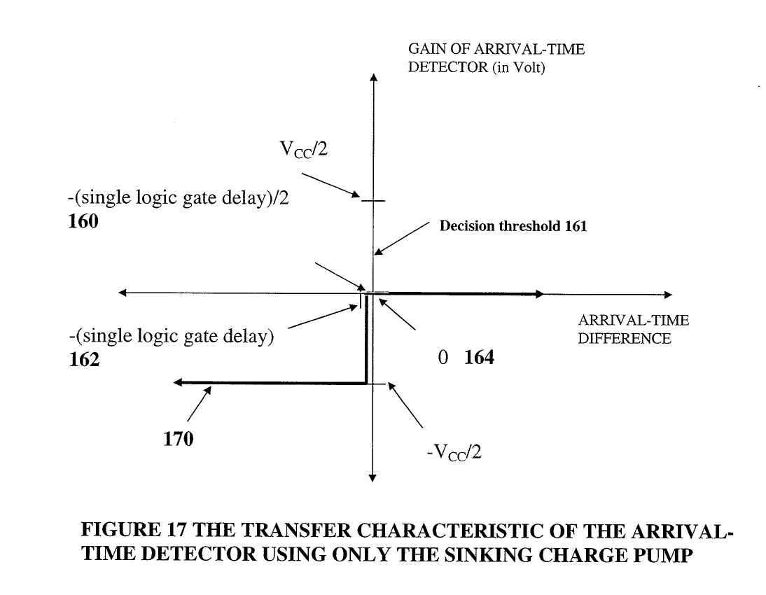

If we use the final polarity output 144 from the digital arrival-time detector 137 as shown in FIG. 14 as the enable signal to drive a sinking charge pump 129 as shown in FIG. 16, we will have a new digital arrival-time detector 139 for the signal from VCO 112 as the first supplement embodiment. This new digital arrival-time detector 139 with only a sinking charge pump as the output driver only needs an enable signal to control the single-ended charge pump output driver 146 because the polarity of the single-ended charge pump output driver 146 is already fixed to be negative. Since the output of the OR logic gate 140 is H by default, the sinking charge pump 129 will remain OFF until the signal from VCO 112 becomes the leading signal. The digital arrival-time detector 139 with only a sinking charge pump output driver is thus a precise digital arrival-time detector when the signal from VCO 112 is ahead of the reference signal 110 and the transfer characteristic of the digital arrival-time detector 139 with only the sinking charge pump output can be shown as in FIG. 17.

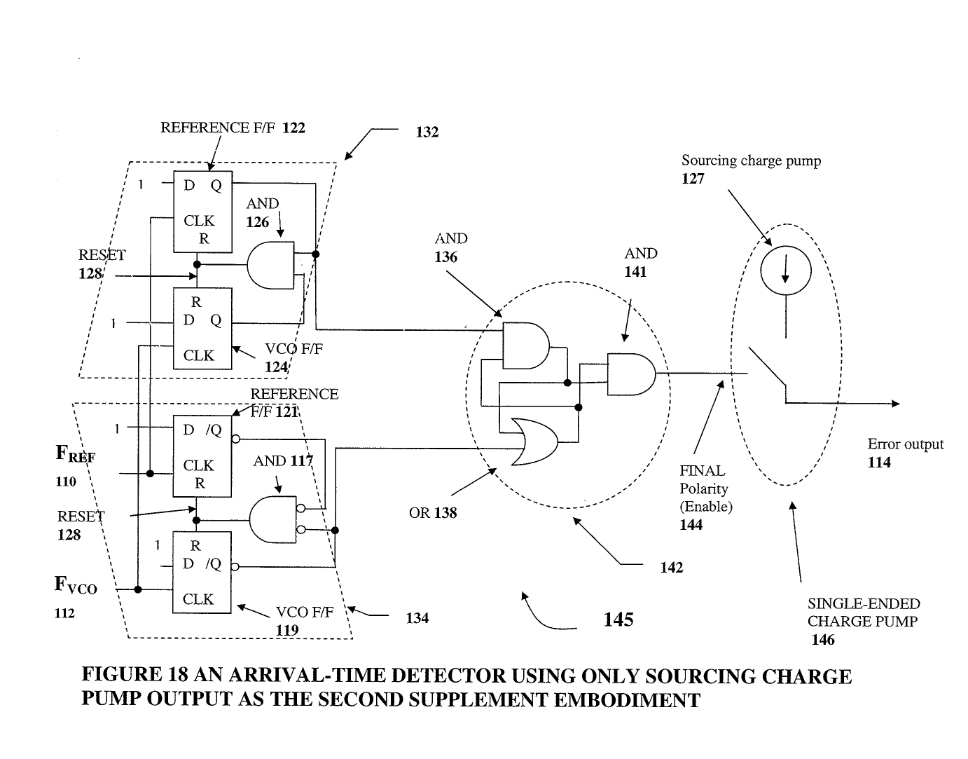

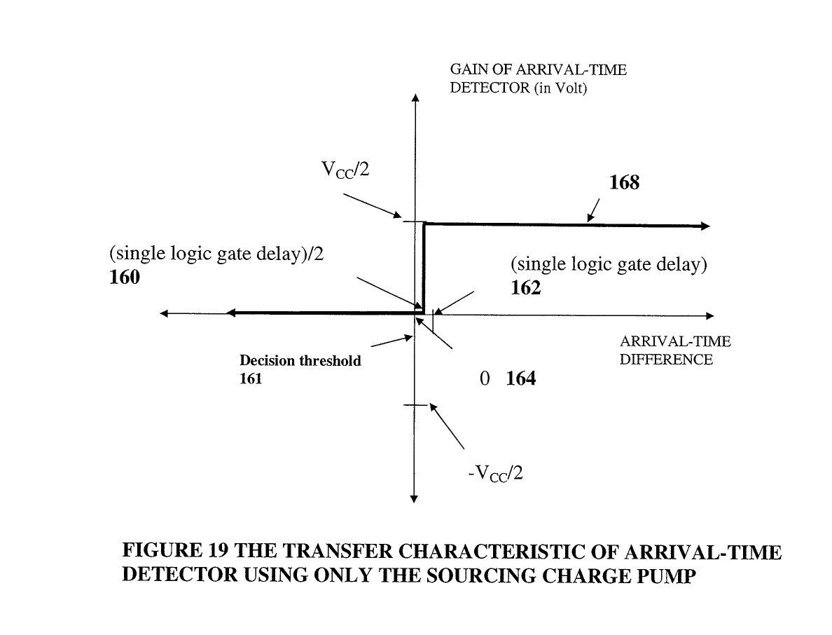

Likewise, if we replace the OR logic gate 140 of the perfect digital arrival-time detector 137 with an AND logic gate 141 and if we use the final polarity output 144 from this digital arrival-time detector 137 as the enable signal to drive a sourcing charge pump 127 as shown in FIG. 18, we will have a new digital arrival-time detector 145 with a single-ended charge pump output driver for the reference signal 110 as the second supplement embodiment. The new digital arrival-time detector 145 with only a sourcing charge pump output driver 127 only needs an enable signal to control the single-ended charge pump output driver 146 because the polarity of the single-ended charge pump output driver 146 is already fixed to be positive. Since the output of the AND logic gate 141 is L by default, the sourcing charge pump 127 will remain OFF until the reference signal 110 becomes the leading signal. The digital arrival-time detector 145 with only the sourcing charge pump output driver is thus a precise digital arrival-time detector 145 when the reference signal 110 is ahead of the signal from VCO 112 and the transfer characteristic of the digital arrival-time detector with only the sourcing charge pump output is as shown in FIG. 19.

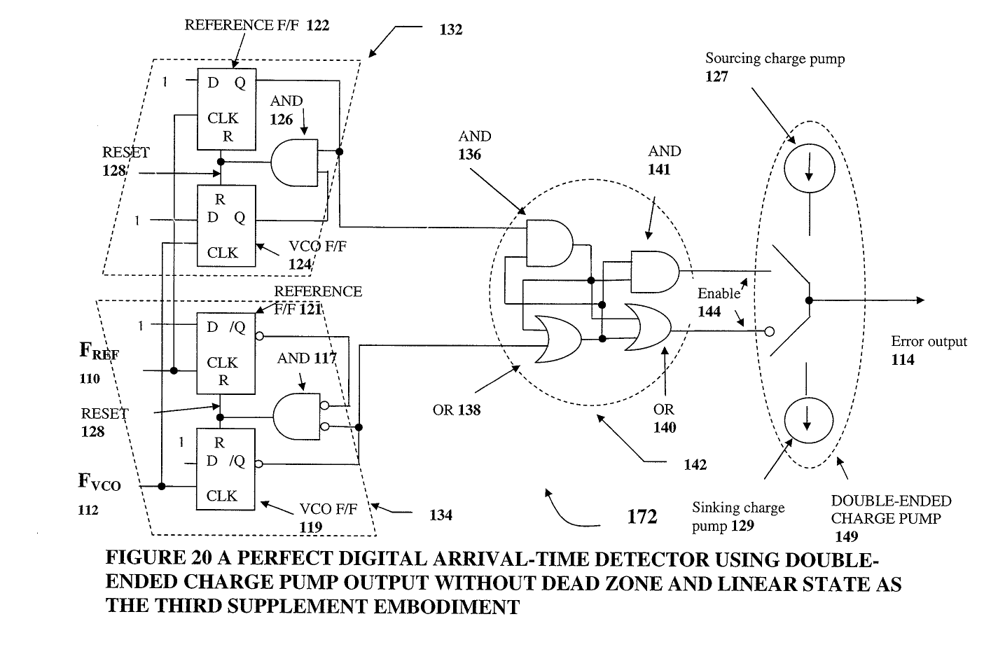

Since the polarity decisions of the digital arrival-time detectors 139 and 145 are exclusive and the two designs of digital arrival-time detectors 139 and 145 share many of the common components, we can combine them together to produce a perfect digital arrival-time detector with double-ended charge pump as the output driver 172 as shown in FIG. 20 as the third supplement embodiment. A normal single-ended charge pump output driver 146 requires two different input signals, a final enable signal 147 and a final polarity signal 144, but a double-ended charge pump output driver 149 requires only two enable signals 144. The double-ended charge pump output driver 149 is usually better than the single-ended charge pump output driver 146 because it is balanced.

As can be seen from this FIG. 17, the sinking charge pump 129 will remain in the default state and is completely OFF until the signal from VCO 112 becomes the leading signal. The sinking charge pump 129 will not be fully turned ON until the signal from VCO 112 is leading the reference signal 110 by a propagation delay time of a single logic gate 162. Before the sinking charge pump 129 is fully turned ON and the arrival-time difference is less than the propagation delay time of a single logic gate 162, the sinking charge pump 129 will bounce between ON and OFF. The duty cycle of the bouncing depends upon how far the arrival-time difference is from the decision threshold 161 of the zero arrival-time difference point 164. During the bouncing decision period, the sinking charge pump 129 will sink in more current as the arrival-time difference is moving away from the decision threshold 161 of the zero arrival-time difference point 164 until the arrival-time difference is more than the propagation delay time of a single logic gate 162. After this point, the sinking charge pump 129 will become fully ON and the amount of output current remains constant. As a result, the polarity of the error output signal 114 of the digital arrival-time detector 139 is always accurate and the final error correction output voltage to the VCO 115 will be gradually reduced to zero when the arrival-time difference between the two input signals is approaching zero.

As can be seen from FIG. 19, the sourcing charge pump 127 will remain in the default state and is completely OFF until the reference signal 110 becomes the leading signal. The sourcing charge pump 127 will not be fully turned ON until the reference signal 110 is leading the signal from VCO 112 by the propagation delay time of a single logic gate 162. Before the sourcing charge pump 127 is fully turned ON and the arrival-time difference is less than the propagation delay time of a single logic gate 162, the sourcing charge pump 127 will bounce between ON and OFF. The duty cycle of the bouncing decision depends upon how far the arrival-time difference is from the decision threshold 161 of the zero arrival-time difference point 164. During the bouncing decision period, the sourcing charge pump 127 will pump out more current as the arrival-time difference is moving away from the decision threshold 161 of zero arrival-time difference point 164 until the arrival-time difference is more than a propagation delay time of a single logic gate 162. After this point, the sourcing charge pump 127 will become fully ON and the amount of output current remains constant. As a result, the polarity of the error output signal 114 from the digital arrival-time detector 145 is always accurate and the final error correction output voltage to the VCO 115 will be gradually reduced to zero when the arrival-time difference between the two input signals is approaching zero.

Since the outputs of AND logic gate 141 and OR logic gate 140 are exclusive, the two output charge pumps 127 and 129 of the double-ended charge pump output driver 149 will never be turned on at the same time and there will be no discontinuity glitch whatsoever. This design thus completely solves the discontinuity glitch problem of the traditional PFD 132 with double-ended charge pump output driver.

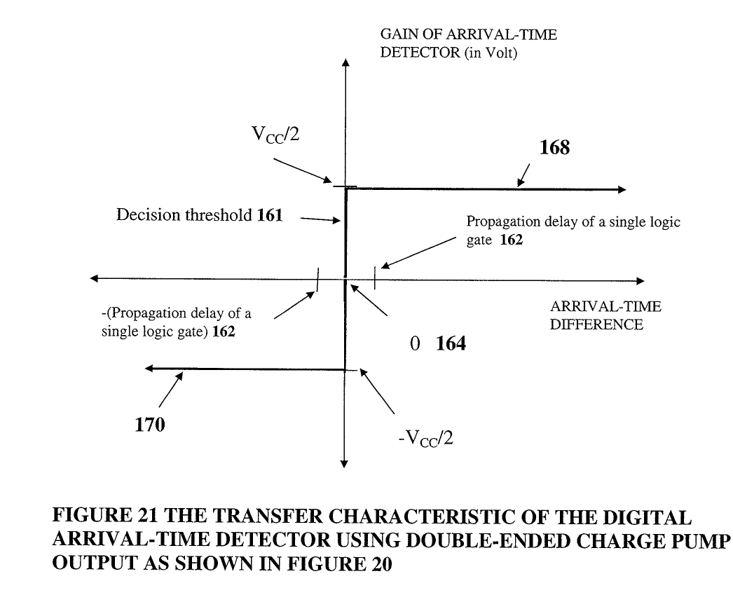

The decision threshold 161 of the perfect digital arrival-time detector 172 with double-ended charge pump output driver 149 is located at exactly the zero arrival-time difference point 164 without offset as shown in FIG. 21. This is because the AND logic gate 141 will remain completely OFF when the signal from VCO 112 is ahead and the OR logic gate 140 will remain completely OFF when the reference signal 110 is ahead so that the decision threshold 161 is at exactly the zero arrival-time difference point 164. The bouncing decision will only cause the sinking charge pump 129 to either sink in current from the loop filter or not or sourcing charge pump 127 to either pump out current or not so that the polarity of the decision output is always correct but the amount of correction can vary and totally depend upon how far the arrival-time difference is away from the decision threshold 161 when the arrival-time difference between the two input signals is within +/−(a propagation delay time of a single-logic gate) 162.

Since the time period of the polarity signals (now is the enable signals 144 for the double-ended charge pump) of the perfect digital arrival-time detector 172 is always longer than the arrival-time difference by four times the propagation delay of a single logic gate, both the sinking 129 and sourcing 127 charge pumps will always be turned on completely regardless of how small the arrival-time difference is. As a result, both the dead zone and linear state of the charge pump output driver are avoided and the digital arrival-time detector with double-ended charge pump 172 becomes an ideal perfect digital arrival-time detector 116 with no decision offset. The output transfer characteristic of the final error correction output to the VCO 115 of the digital arrival-time detector with double-ended charge pump 172 is thus the same as the ideal transfer characteristic as shown in FIG. 11.

Only four circuit modules are needed for all the digital arrival-time detectors 116 using double-ended charge pump output driver 149. They include the PFD 132, the complementary PFD 134, polarity decision and enabling circuit 142 and the double-ended charge pump output driver 149. The polarity decision module 142 is now also working as the enabling module for the double-ended charge pump output driver 149.

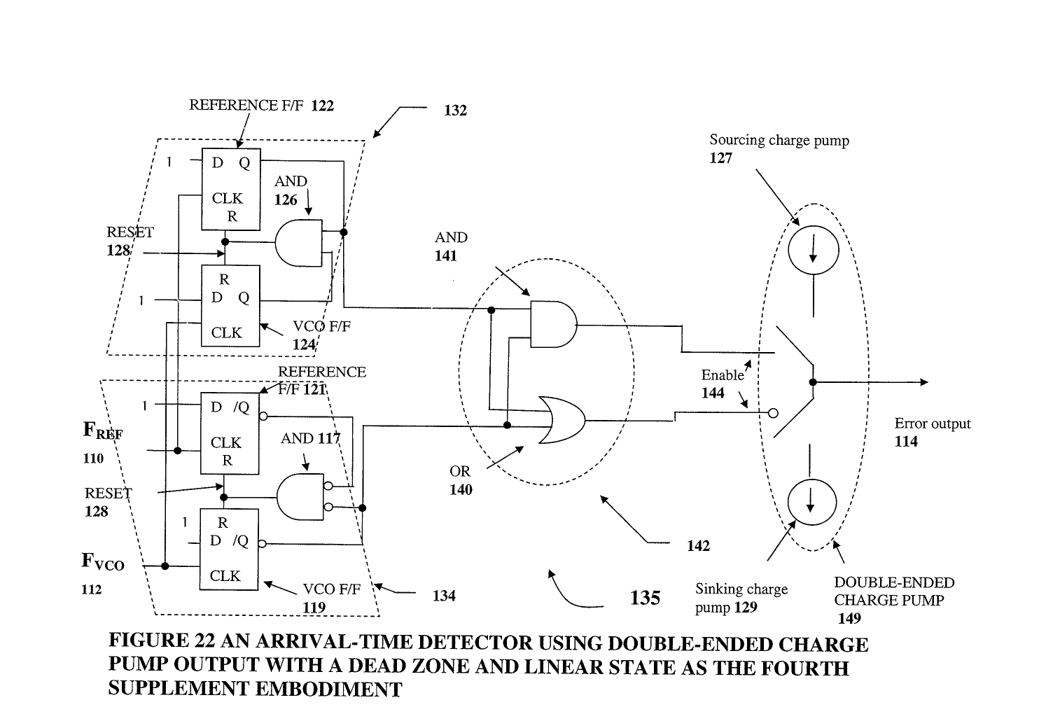

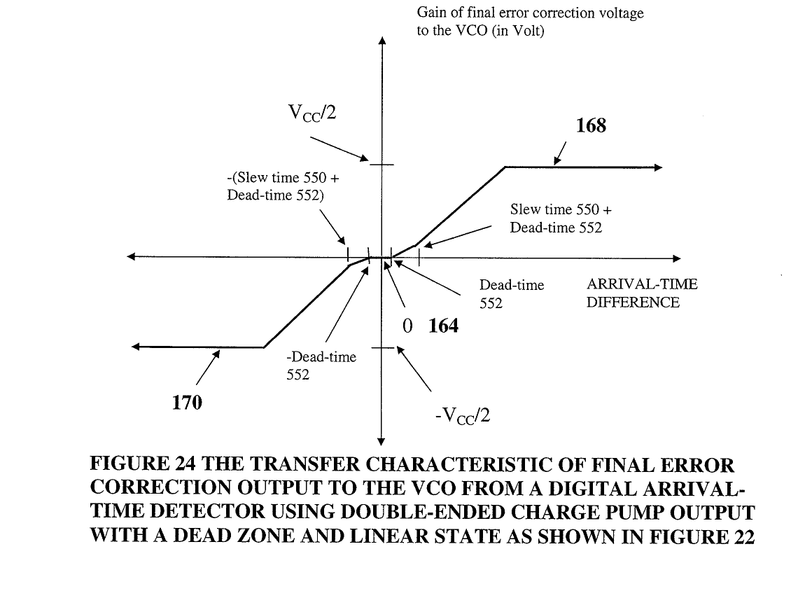

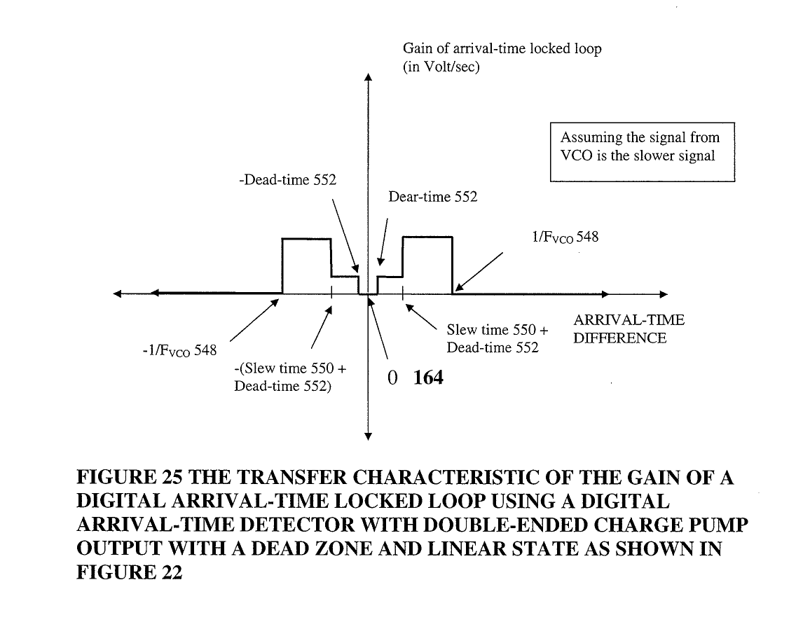

In the design of FIG. 20, we used an AND logic gate 136 and an OR logic gate 138 to lock in the polarity output signal to lengthen the enable signals 144 to prevent the dead zone and linear state of the charge pump outputs. If the dead-zone and linear state are not critical, we can eliminate the AND logic gate 136 and OR logic gate 138 and produce a digital arrival-time detector using a double-ended charge pump output 135 with a dead zone as shown in FIG. 22 as the fourth supplement embodiment. The transfer characteristic of the digital arrival-time detector 135 is as shown in FIG. 23 that exhibits a dead-zone and a linear state output around the decision threshold 161 at the zero arrival-time difference point 164. The dead-zone and linear state will unfortunately distort the transfer characteristic of the final error correction voltage to the VCO 115 as shown in FIG. 24 so that the gain of the arrival-time locked loop is no longer a constant and the gain is zero around the zero arrival-time difference point 164 due to the dead zone. The gain of the arrival-time locked loop 100 using the digital arrival-time detector 135 can be shown as in FIG. 25. As can be seen from FIG. 25, the loop gain of the arrival-time locked loop 100 using digital arrival-time detector 135 has three different levels due to the dead zone and linear state. The arrival-time locked loop 100 using the digital arrival-time detector 135 will be less powerful and will take a longer time to acquire and lock the two input signals due to the loss of gain; nevertheless, the loss of gain around the zero arrival-time difference point 164 can reduce the phase noise for VCO 108 since the error output signals 114 sent to the VCO 108 from the digital arrival-time detector 135 is minimum when the loop is locked.

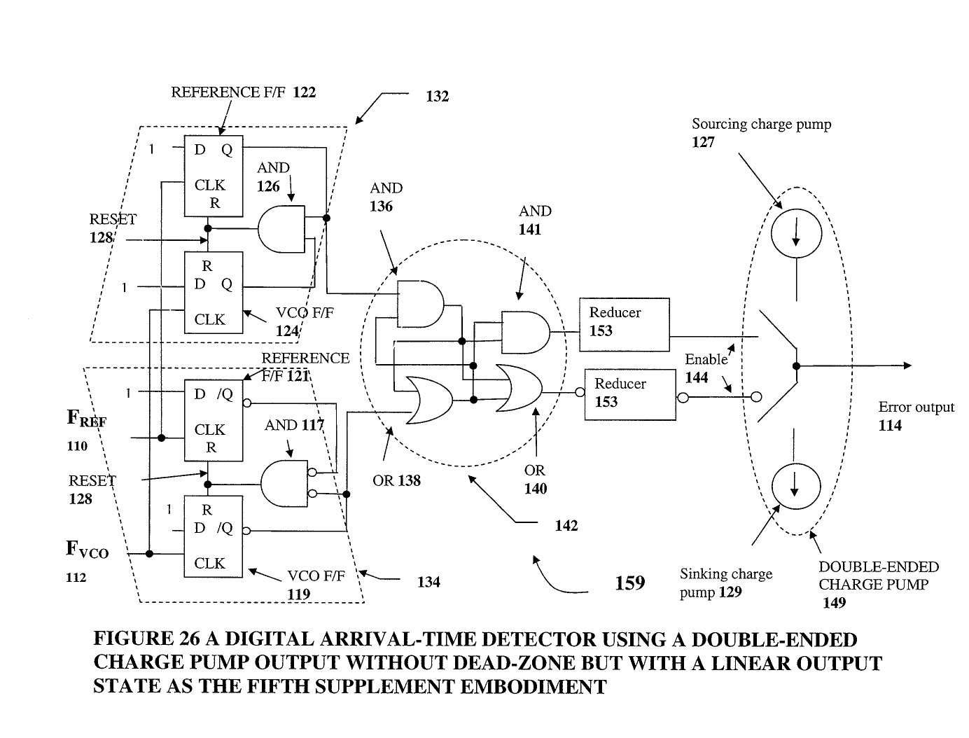

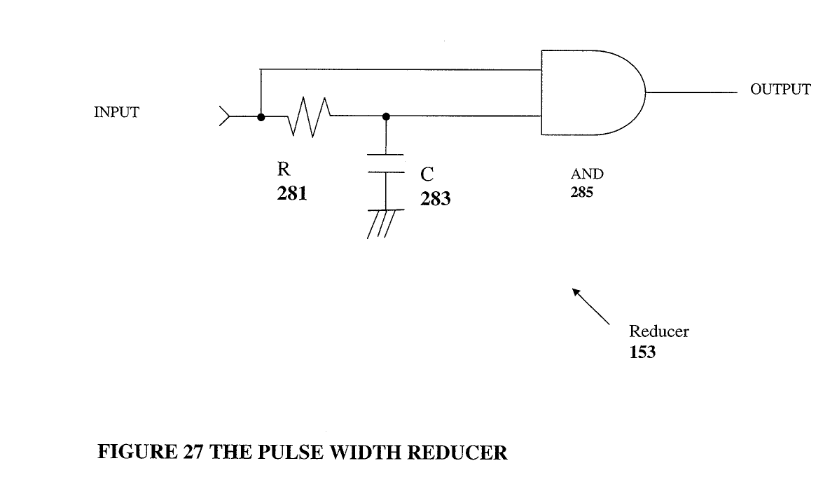

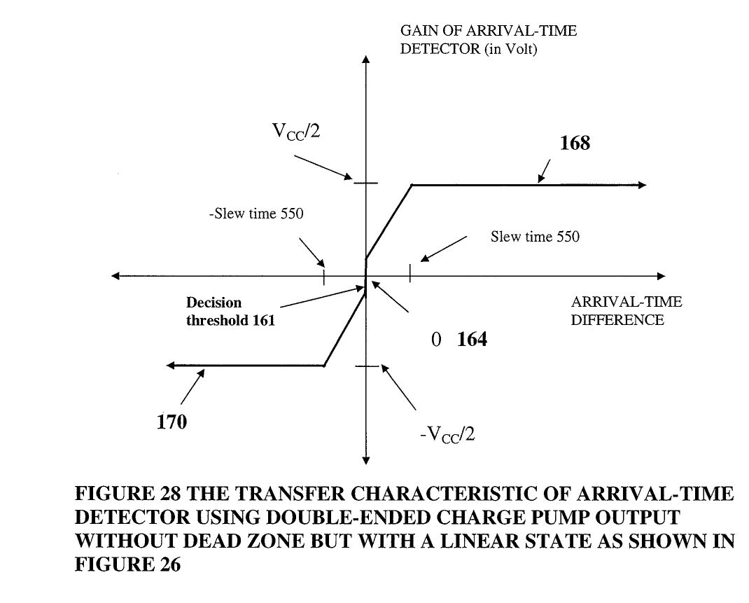

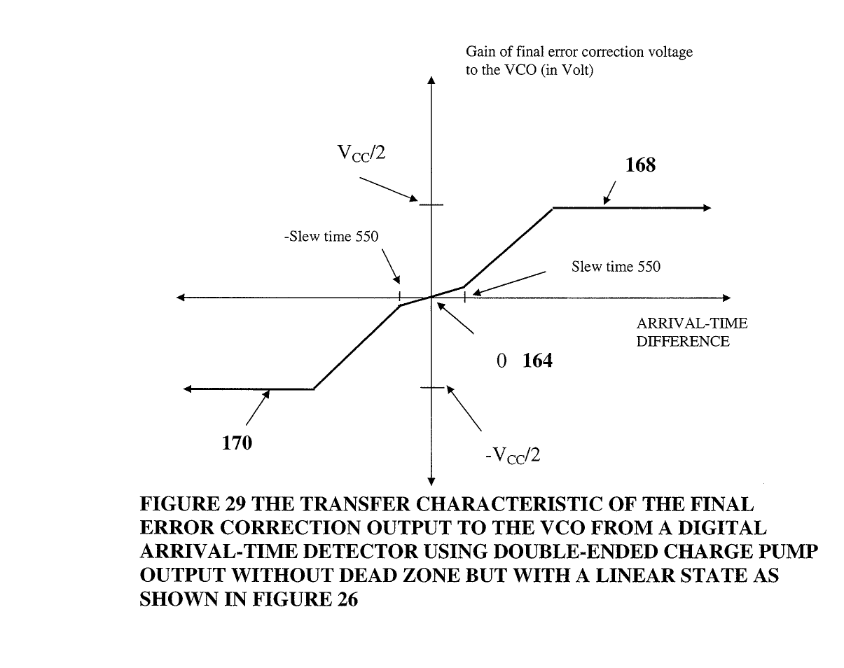

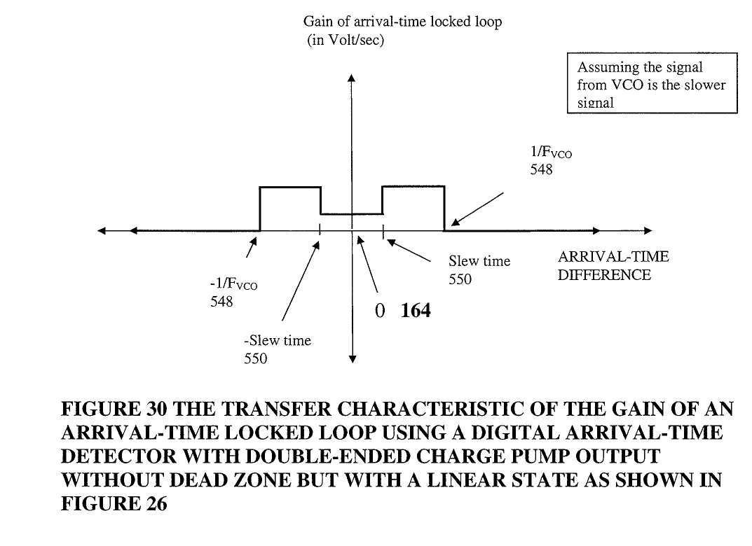

A compromise design to eliminate the dead zone completely but still allow the double-ended charge pump output driver 149 to be operated in the linear state is as shown in FIG. 26 as the fifth supplement embodiment. In this design, a pulse width reducer circuit 153, as shown in FIG. 27, is used for each of the enable signal 144 so that the width of the enable signal 144 is just long enough to prevent the dead zone but not long enough to turn on the double-ended charge pump output driver 149 completely. The arrival-time locked loop 100 using the digital arrival-time detector 159 can still acquire and lock the two input signals fairly quickly and since the gain of the digital arrival-time detector 159 is smaller when the loop is in locked condition, the VCO 108 will not be disturbed as much by the digital arrival-time detector 159 when the loop is in locked condition. As a result, the digital arrival-time detector 159 offers a compromised performance between the designs of digital arrival-time detector 135 and 172. The transfer characteristic of the digital arrival-time detector 159 is as shown in FIG. 28 and the characteristic of the final error correction voltage from the arrival-time detector 159 to the VCO 115 is as shown in FIG. 29. The loop gain of the arrival-time locked loop 100 using digital arrival-time detector 159 is shown in FIG. 30 with two different gain levels.

Although the digital arrival-time detector 116 is a digital device by itself since it produces an error output signal 114 that is either H or L when the charge pump output driver 146 or 149 is enabled, its operation inside the loop is linear. This is because that the charge pump output driver 146 or 149 is only enabled for a time period equal to the difference of arrival-time between the two input signals or with a slight extra delay time in addition to the difference of arrival-time between the two input signals to overcome the threshold of the charge pump output driver 146 or 149 to prevent the dead-zone and linear state. The larger the arrival-time difference between the two input signals, the longer period of time the charge pump output driver 146 or 149 will pump up or sink down the final error correction voltage 115. As a result, the final error correction voltage 115 to the VCO is produced linearly according to the difference of the arrival-time at the inputs. In this sense, the behavior of digital arrival-time detector 116 is linear even though the digital arrival-time detector 116 itself is digital.

The dead zone jittering problem is solved completely with the digital arrival-time detectors 116 because at the zero arrival-time difference point, the charge pumps are completely turned OFF or bouncing between ON and OFF at 50% duty cycle so that the net output current at the zero arrival-time difference point is always zero. In contrast, both of the charge pumps of the traditional PFD 132 with double-ended charge pump output are always ON at the zero arrival-time difference point so that there is always some error current at the output to generate the discontinuity glitch.

### Acquisition Behavior of the Arrival-time Locked Loop

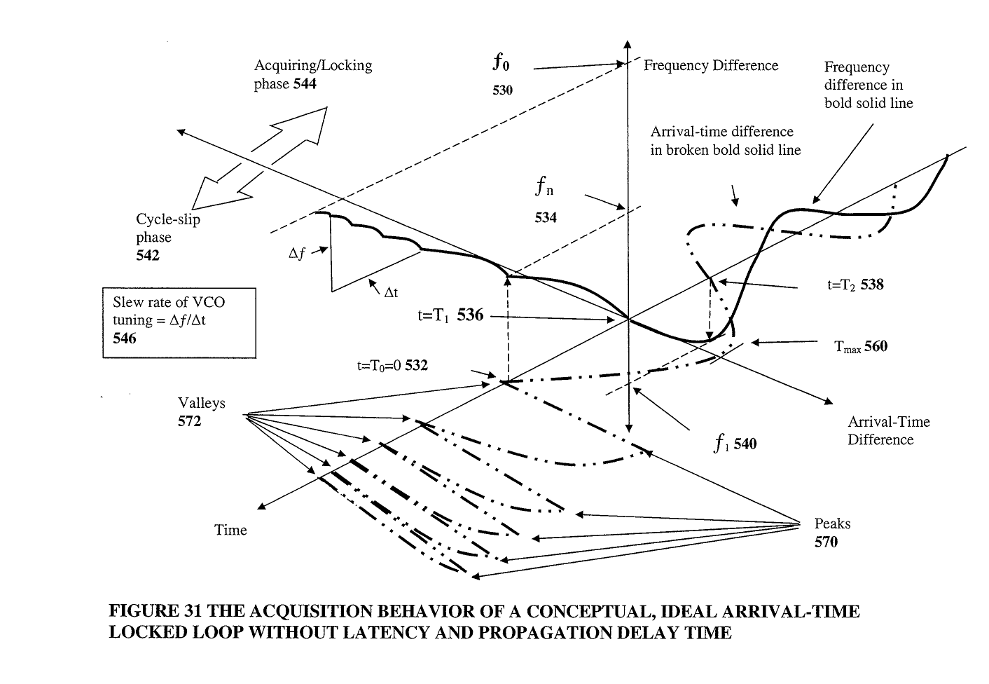

The arrival-time detector 104 can correct the phase and frequency of the local signal 112 generated from the VCO until they are synchronized to the phase and frequency of the reference signal 110. The process of synchronization, or is called acquisition process, is a very complicated process. The acquisition behavior of a conceptual, ideal arrival-time locked loop 100 using an arrival-time detector 104 that does not have any latency delay time and propagation delay time is shown in FIG. 31. The acquisition process of an arrival-time locked loop 100 can only be described in a 3-D plot as shown in the FIG. 31 because there are actually two acquisition processes going on at the same time, one to acquire the frequency and the other one to acquire the arrival-time of the signals.

Assuming that the initial frequency difference between the reference signal 110 and the signal from VCO 112 is f₀ 530 and the signal from VCO 112 is the slower signal and the initial frequency difference is within the capture range of the arrival-time detector 104, since the signal from VCO 112 is falling behind all the time, the arrival-time detector 104 will be pumping up the frequency of the signal from VCO 112 all the time until the signal from VCO 112 finally arrives earlier than the reference signal 110. So the frequency difference between the two input signals will be getting smaller and smaller after the acquisition begins. We further assume that the last time the two signals arrive at the same time before the frequency difference changing the polarity is at time equal to T₀ 532 which is also the reference time for the acquisition process and we also assume the time is 0 at T₀ 532 and the frequency difference at T₀ 532 is f₀ 534 which by definition is the natural frequency of the loop. We will know soon why it is called the natural frequency of the loop.

Since the two signals arrive at the same time at T₀ 532, there will be no correction for the first arrival-time comparison cycle after T₀ 532. Due to the frequency difference, the two signals will arrive at a different time at the beginning of the second arrival-time comparison cycle after T₀ 532. At the beginning of the second comparison cycle after T₀ 532, the two signals will have the arrival-time difference of

$$Δ {T}_{1} = \frac{{ω}_{n}}{{ω}_{REF}} * T = \frac{{ω}_{n} * 2 * π}{{ω}_{REF} * {ω}_{VCO}} \qquad equ . 6$$

where T is the time period of the arrival-time comparison cycle and ω_{REF} is the angular frequency of the reference signal 110 and ωₙ is the angular natural frequency of the loop. We need to use ωₙ instead of fₙ in calculating the arrival-time difference at the end of the first arrival-time comparison cycle because the signals have traveled a cycle of 2π radian.

Since the signal from VCO 112 is the slower signal, the time period of the arrival-time comparison cycle T is equal to the period of the signal from VCO 112 (2π/ω_{VCO}). Since the charge pump of the arrival-time detector 104 will be turned on for a time period equal to ΔT₁ at the beginning of the second arrival-time comparison cycle after T₀ 532, the frequency of the VCO will be corrected for the duration of ΔT₁ and the frequency correction occurs at the beginning of the second arrival-time comparison cycle after the arrival-time difference of ΔT₁ has occurred is then equal to

Δf₂=K*Iₒᵤₜ*ΔT₁/C equ. 7

Where Iₒᵤₜ is the amount of charge pump output current in Ampere and C is the capacitance of the loop filter in Farad and K is the sensitivity of the VCO in Hz/Volt or 1/(sec*Volt). The unit for the VCO sensitivity used in this disclosure is different than the unit rad/(sec*Volt) used in traditional analysis of the PLL. Using Hz/Volt will make much more sense for the VCO sensitivity because when we measure the VCO sensitivity, we will measure the frequency change of the VCO output signal when the VCO tuning voltage is changed by a volt. It is measured as Hz/Volt.

Hz(1/sec) and rad/sec have been very confusing to all engineers all the time. These two units are completely different in nature! The unit Hz (1/sec) tells you how many cycles have passed in a second and it is used to describe a static physical phenomenon. In contrast, the unit of rad/sec tells you how many radians have traveled in a second and it is used to describe a physical phenomenon in motion.

So the frequency difference at the beginning of the second arrival-time comparison cycle after the first frequency correction is equal to fₙ−Δf₂ and the arrival-time difference at the end of the second arrival-time comparison cycle is equal to

$$Δ {T}_{2} = \frac{{ω}_{n} - {Δω}_{2}}{{ω}_{REF}} * \frac{{2}^{*} π}{{ }_{(} {ω}_{VCO -} {Δω}_{2 )}} \qquad equ . 8$$

As a result, the frequency of VCO at the beginning of the third arrival-time comparison cycle after T₀ 532 will be corrected by the time period of ΔT₁+T₂. The correction time for the third arrival-time comparison cycle is now almost double of the correction time for the second arrival-time comparison cycle because the second arrival-time comparison cycle only reduced the frequency difference by a small amount. So the frequency correction at the beginning of the third arrival-time comparison cycle is

Δf₃=K*Iₒᵤₜ*ΔT₂/C+K*Iₒᵤₜ*ΔT₁/C equ. 9

So the frequency difference at the beginning of the third arrival-time comparison cycle is now fₙ−Δf₂−Δf₃. It is thus clear that the frequency difference at the beginning of each new arrival-time comparison cycle will become less and less but the correction time for the VCO of each new arrival-time comparison cycle will become longer and longer. The calculations for both the arrival-time difference and VCO frequency correction of each new arrival-time comparison cycle will be getting more complicated quickly as the number of comparison cycle increases. This trend will continue and the frequency difference will eventually reach zero at t=T₁ 536 and at this moment, the VCO correction time will be at the maximum Tₘₐₓ 560. As a result, the frequency of the signal from VCO 112 will continue to be corrected even though it has already reached the same frequency as the reference signal 110 and the frequency difference is zero. The frequency of the signal from VCO 112 is still being corrected because the difference of arrival-time is not zero.

At the time=0, the two input signals arrived at the same time but with a different frequency and now for the first time, at time=T₁ 536 the frequency of the signal from VCO 112 reaches the desired synchronization frequency but with a non-zero arrival-time difference. The arrival-time difference is non-zero at time=T₁ 536 due to the frequency corrections occurred between T₀ 532 to T₁ 536. At t=T₁ 536, the frequency difference is eliminated, but the arrival-time difference is not. As a result, the arrival-time detector 104 will continue to push the VCO in the same direction, so that the frequency of the the signal from VCO 112 is now faster than the frequency of the reference signal 110. The arrival-time detector 104 will only change the direction to push the VCO when the arrival-time difference between the two input signals is crossing over the zero arrival-time difference point at time=T₂ 538.

As the frequency of the signal from VCO 112 is being pushed higher and higher passing first frequency synchronization point at the time=T₁ 536, the frequency difference of the two signals will now increase more and more but the arrival-time difference will be now getting smaller and smaller and eventually the arrival-time difference will become zero at time=T₂ 538. At this point at time=T₂ 538, the frequency difference f₁ 540 must be less than the initial frequency difference f₁ 534 if the acquisition process is to converge. In fact, at time=T₂ 538, we can treat it as the beginning of a new acquisition cycle with an initial frequency difference of f₁ 540 and f₁ 540 becomes the new natural frequency for the second acquisition cycle. The whole synchronization process can then repeat itself and every time the two input signals arrive at the same time again, the frequency difference will become smaller than the frequency difference at the previous arrival-time synchronization point and a new acquisition cycle will begin and eventually, the two signals will be synchronized both in frequency and arrival-time. If f₁ 540, the frequency difference between the two signals at the end of the first synchronization cycle after T₀ 532, is more than the frequency difference fₙ 534 at the beginning of the first synchronization cycle after T₀ 532, then the frequency difference does not converge and the signal from VCO 112 will never be synchronized to the reference signal 110. As a result, the acquisition process can be divided into many small acquisition cycles that each one lasts only half of the period of the natural frequency of each acquisition cycle and each acquisition cycle is made of many arrival-time comparison cycles.

In general, the synchronization process of the arrival-time locked loop 100 can be divided into two phases, the cycle-slip phase 542 and the acquiring/locking phase 544 as shown in FIG. 31. Before we start to analyze the two phases, we need to understand the slewing capability of the arrival-time locked loop 100 and its significance. As explained earlier, the slew rate of the VCO that the arrival-time locked loop 100 can control is equal to the gain of the arrival-time locked loop 100 times the VCO sensitivity. And the gain of the arrival-time locked loop 100 G is determined by the charge pump output current Iₒᵤₜ and capacitance of the loop filter 106 as follows,

G=Iₒᵤₜ/C equ. 10

The slew rate 546 of VCO of the arrival-time locked loop 100 must be faster than the fastest slew rate that can occur to the signals at the inputs of the arrival-time detector 104 so that it is one of the most important specifications we need to satisfy when designing the arrival-time locked loop 100. In some applications, like the cell phone that we need to switch channels frequently and quickly, the specification for VCO slew rate is very rigid.

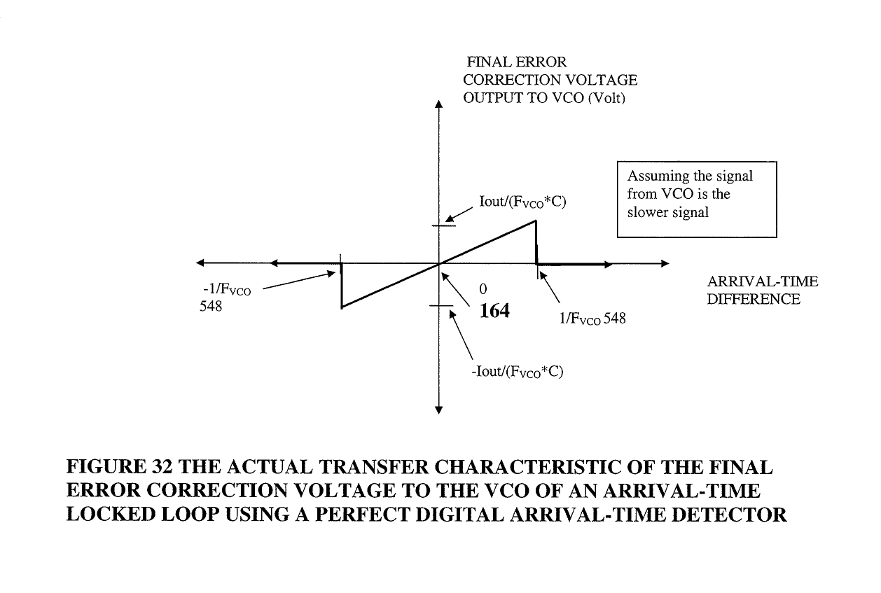

The ideal transfer characteristics of the final error correction voltage to the VCO 115 from a perfect digital arrival-time detector 137 or 172 as shown in FIG. 11 was obtained by comparing only one cycle of the two input signals. Unfortunately, this is not what is happening in most applications. In most applications, the arrival edges from each signal will keep coming all the time. As a result, the arrival-time difference axial of the actual transfer characteristics of the final error correction voltage to the VCO 115 from the perfect digital arrival-time detector 137 or 172 should be limited by the period of the slower input signal and the actual transfer characteristic of the final error correction voltage to the VCO 115 become as shown in FIG. 32, assuming the signal from VCO 112 is the slower signal.

Although a perfect digital arrival-time detector 137 or 172 has no limit on the range of arrival-time difference that it can be operated, the maximum arrival-time difference between two input signals to the perfect digital arrival-time detector 137 or 172 is still limited by the period of the slower signal. This is quite different from using a mixer as the analog arrival-time detector that the maximum arrival-time difference is limited by the period of the faster signal. As a result, the perfect digital arrival-time detector 137 or 172 can produce more gain for the arrival-time locked loop 100 than the mixer.

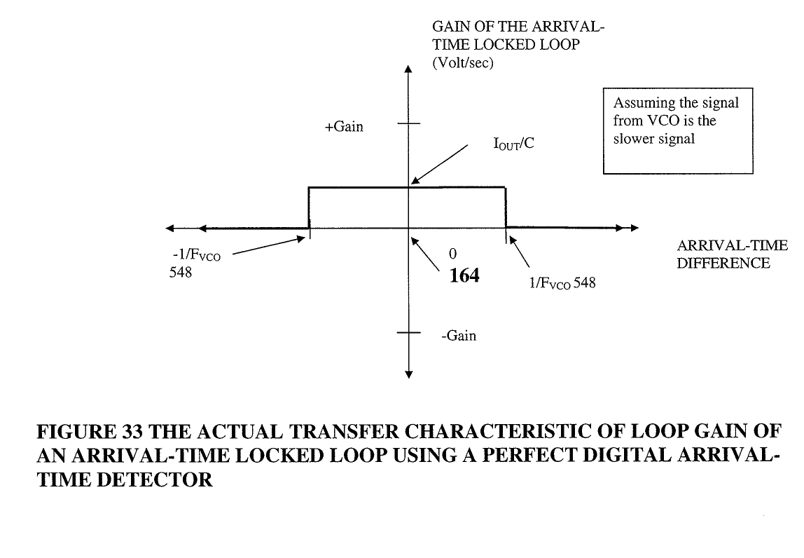

If we take the derivative of the actual transfer characteristic of the final error correction voltage to the VCO 115 from a perfect digital arrival-time detector 137 or 172 as shown in FIG. 32 with respect to the arrival-time difference, we will have the gain of the arrival-time locked loop 100 using a perfect digital arrival-time detector 137 or 172 as shown in FIG. 33. As can be expected, the arrival-time locked loop 100 using a perfect digital arrival-time detector 137 or 172 has a constant positive gain. It is quite obvious that in order to maintain a constant positive gain through the whole arrival-time difference of +/−1/(F_{VCO}) 548, the following equation must be satisfied,

1/(F_{VCO})<(Vcc/2)*(C/Iₒᵤₜ) equ. 11

This inequality equation limits the maximum loop gain for the arrival-time locked loop 100 using a prefect digital arrival-time detector 137 or 172. This inequality equation requires that the period of the slower input signal must be less than the limit of half of the linear range of the perfect digital arrival-time detector 137 or 172. If the period of the slower input signal is longer than the limit as shown in equation 11, then the gain of the loop will become zero and the loop will never be able to acquire and lock the reference signal 110. What equation 11 is telling us is that when the period of the slower input signal is longer than the limit as shown in equation 11, the output of the perfect digital arrival-time detector 137 or 172 will be saturated and stay at the power supply rails so that the arrival-time locked loop 100 won't provide any gain to acquire and lock the signals. So the loop gain of the arrival-time locked loop 100 using the perfect digital arrival-time detector 137 or 172 is limited at both the high end and low end.

The same limitation of the loop gain also occurs to the arrival-time locked loop 100 using the other digital arrival-time detectors 116 with characteristics as shown in FIGS. 23 and 28.

As shown in FIG. 31, assuming that the initial frequency the VCO is way below the frequency of the reference signal 110 and the frequency of the signal from VCO 112 is being pumped up by the arrival-time detector 104 and the frequency of the signal from VCO 112 increases at the rate of Δf/Δt 546 toward the frequency of the reference signal 110. In the beginning of the acquisition process when the frequencies of the two signals are very different, the acquisition process is in the cycle-slip phase 542. During the cycle-slip phase 542, a lot of beat signals occur. A beat signal is generated when a signal is sliding through another signal at a different frequency and at the moment the two signals crossing over each other in phase, the beat signal is generated. The two signals are actually synchronized in arrival-time for a brief moment when they are crossing over in phase but the two signals will run out of sync quickly. When the frequency of the signal from VCO 112 is much slower than the frequency of reference signal 110, the reference signal 110 will arrive at the arrival-time detector 104 earlier than the signal from VCO 112 so that the arrival-time detector 104 will send out mostly H output to speed up the frequency of the signal from VCO 112. The pulse width of the error output 114 sent to the VCO 108 will vary from the maximum of the period of the signal from VCO 112 to 0 and the pulses of the error output 114 can actually change polarity for a brief moment when the beat signal occurs. The amplitudes of the peaks 570 and valleys 572 of the arrival-time corrections caused by the beat signals during the cycle-slip phase 542 are not constant. The amplitude of the peaks 570 of arrival-time correction is determined by the period of the slower signal from VCO 112 which is constantly decreasing during the cycle slip phase 542. While although most of the valleys 572 of the arrival-time corrections are close to zero, they can slip into the negative side for a brief moment sometimes.

The cycle slip phenomenon is usually not obvious to observe in the acquisition process until the two frequencies are getting closer in frequency and the frequency of the beat signal is low. Since there is always a net frequency correction in each correction period between the cycle slips because the arrival-time detector 104 sends out almost all positive output correction during the cycle-slip phase all the time, the cycle slip does not affect the capability of the loop to acquire the signal. The brief moment of reverse polarity of the arrival-time difference when the two signals are synchronized briefly during the cycle-slips can slow down the acquisition process but its effect is usually insignificant since it does not last too long.

The cycle-slip phase occurs only during the beginning of the synchronization process when the frequency difference is large. The cycle-slips will keep on happening until when the frequency difference changes the polarity. Once the frequency difference changes the polarity at time=T₁ 536, the synchronization process enters the acquiring/locking phase 544. In this phase, the cycle-slip should not happen again and the polarity of both the frequency difference and arrival-time difference will bounce between positive and negative all the time and eventually both the frequency difference and arrival-time difference will be reduced to zero when the loop is finally locked. The acquiring/locking phase 544 usually lasts much longer than the cycle-slip phase 542 and the behavior of the arrival-time locked loop 100 during acquiring/locking phase 544 determines how quickly the loop can acquire and lock the signals.

Whether if the arrival-time locked loop 100 can successfully and quickly acquire the reference signal 110 and lock the VCO to the reference signal 110 or not is determined by three factors, the latency delay time of the loop, the propagation delay time of the loop and the slew rate of the VCO. The latency delay time of the loop indicates how fast the arrival-time detector 104 responds to the changing status of the inputs. The propagation delay time of the loop indicates how fast the loop sends the response of the error output signal 114 from the arrival-time detector 104 back to the input of the arrival-time detector 104. In order for the arrival-time locked loop 100 to successfully acquire and lock the reference signal 110, the VCO 108 must be able to be steered at a rate fast enough to track the frequency movements of the signals at the inputs of the arrival-time detector 104. As stated before, the slew rate of the VCO 546 is determined by the loop gain times the sensitivity of VCO and the loop gain is determined by the current output from the charge pump divided by the capacitance of the loop filter 106. The capacitance of the loop filter 106 must be chosen in such a way that it is not only large enough to prevent the undesired noises of the arrival-time comparison from reaching the VCO but also small enough to be responsive to the changing decisions from the arrival-time detector 104. The goal of the design process for the arrival-time locked loop 100 is simply to find out the optimal value of the capacitance for the loop filter 106.

Both the latency delay time and the propagation delay time are the delay time a device takes to produce an output after receiving an input. The difference between the latency delay time and propagation delay time is mostly in terminology and is completely due to the nature of the device itself. In general, if a device simply passes an input signal to the output without alternating the characteristics of the signal, then the delay time caused by this device is called the propagation delay time. Otherwise, it is called the latency delay time. For example, the delay time of a cable, a filter, a simple logic gate or an amplifier is called the propagation delay time. The delay time of a frequency divider is called the latency delay time since the frequency of the output signal is different than the frequency of the input signal. Likewise, the delay time of a frequency mixer, A/D converter or an arrival-time detector is also all called the latency delay time.

Due to the delay caused by the latency delay time and propagation delay time, the arrival-time detector 104 will receive the response from the last correction some time later after a correction was sent out to the VCO 108 from the arrival-time detector 104. As a result, the current feedback information from the VCO at the arrival-time detector's input can be outdated and it can be even so outdated that the arrival-time detector 104 makes a wrong decision to push the VCO into a wrong direction. The latency delay time and propagation delay time allows the frequency of VCO to go into the wrong direction and these two times should be as short as possible. The latency delay time and propagation delay time can cause the gain of the arrival-time locked loop 100 to change the polarity so that the arrival-time locked loop 100 can fail to acquire and lock the signals or the arrival-time locked loop 100 simply oscillates. The sum of the latency delay time and propagation delay time can be called as the loop delay time in brief.

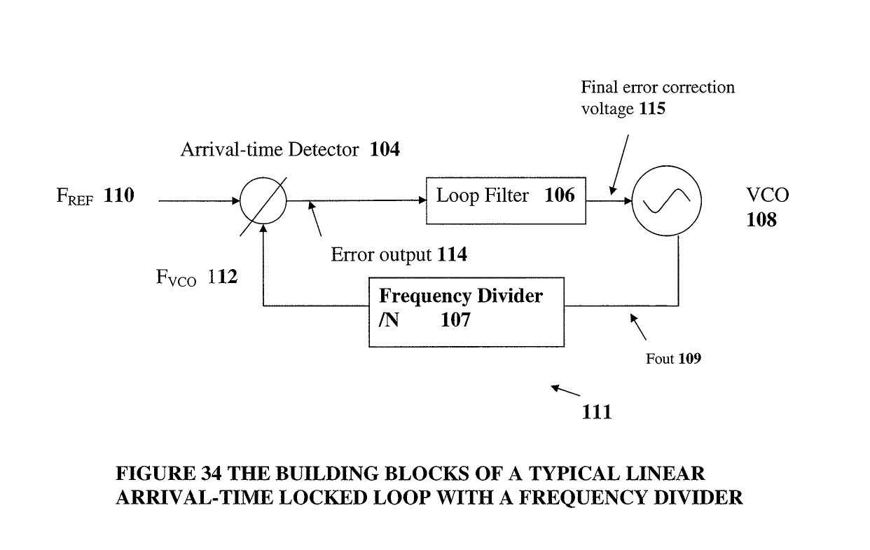

The latency delay time of the arrival-time locked loop 100 is equal to the sum of the latency delay time of the arrival-time detector 104 and the period of the slower arrival-time comparison signal. The latency delay time of the digital arrival-time detector 116 is normally very short since the digital arrival-time detector 116 can send out a correction immediately whenever the first signal arrives. The latency delay time of the digital arrival-time detector 116 is normally equal to the sum of the propagation delay time of a flip-flop and three logic gates. The latency delay time of an analog arrival-time detector is even shorter. The period of the slower arrival-time comparison signal determines how soon a new signal can arrive at the input of the arrival-time detector 104. As a result, the period of the slower arrival-time comparison signal is usually the main contributing factor to the latency delay time of the arrival-time locked loop 100 especially when a frequency divider 107 is used in the feedback path of the loop as shown in FIG. 34. A divide-by-N frequency divider 107 allows the arrival-time locked loop 111 to generate a VCO output signal with a frequency F_{OUT} 109 that is equal to N times the frequency of the reference signal 110. The divide-by-N frequency divider 107, however, can add a latency delay time which is equal to N times the period of the VCO signal and additional propagation delay time caused by the flip-flops of the frequency divider 107 to the loop delay time since the output of the divide-by-N frequency divider 107 will not carry the updated arrival-time information from the VCO until at least N cycles of VCO signals have passed through the frequency divider 107.

The propagation delay time of the arrival-time locked loop 100 is mainly determined by the response time of the loop filter 106. Since the loop filter 106 is also providing an integration function for the error output signal 114, the response time of the loop filter 106 is equal to the duration of the error output signal 114. As a result, the maximum propagation delay time of the loop is also equal to the period of the slower arrival-time comparison signal. As a result, both the latency delay time and propagation delay time of the loop are determined by the period of the slower arrival-time comparison signal. The propagation delay time of the loop will be different between when the loop is locked and when the loop is not locked. When the loop is locked, the duration of the error output signal 114 is mostly near zero so that the propagation delay time of the loop is very short. When the loop is not in the locked condition, the duration of the error output signal 114 can be as long as the period of the slower arrival-time comparison signal. So the total loop delay time can vary between the period of the slower arrival-time comparison input signal and twice the period of the slower arrival-time comparison input signal.

For a loop filter 106 with a capacitance of C 182, the time constant of the loop filter 106 is equal to C*Vcc/(2*I_{OUT}) and Vcc is the power supply voltage to the charge pump output driver of the arrival-time detector 104 and I_{OUT} is the current output of the charge pump. The time constant of the loop filter 106 should be much larger than the period of arrival-time comparison signals in order for the loop filter to become an integrator for the error output signal 114 and in the meantime, a large time constant for the loop filter 106 can also remove the unwanted digital noises from the arrival-time detector 104 to prevent the digital noises from becoming the phase noises to the VCO 108. But unfortunately, a large time constant for the loop filter 106 can also increase the response time for the loop filter 106 and decrease the loop gain.

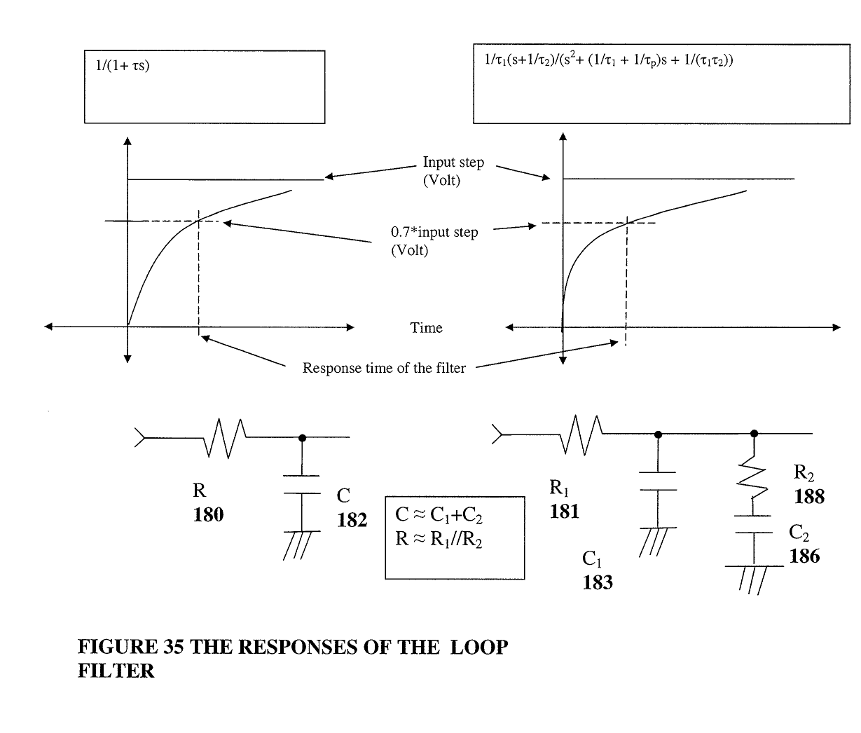

An easy way to speed up or reduce the response time of the loop filter 106 without affecting the time constant of the loop is to add an RC shunt circuit to the loop capacitor C 182 and the time constant of the RC shunt circuit is chosen to be about 10 times of the time constant of the loop filter 106. The responses time of the loop filter 106 with loop capacitor C 182 and the response time of the loop filter 106 with an additional shunt RC circuit to a step input response are shown in FIG. 35. It is clear that the added shunt circuit can effectively reduce the response time of the loop filter 106 but unfortunately, it is really difficult to derive a formula to calculate the exact improvement of the response time from the shunt RC circuit. The best way to design the shunt RC circuit and loop filter 106 is to use a simulation program like SPICE. To design the shunt RC circuit, it is important to maintain the same bandwidth for the loop filter 106 so that the sum of C₁ 183 and C₂ 186 should be approximately equal to the capacitance C 182 of the simple RC loop filter. We basically split the total capacitance C 182 of the simple RC loop filter into two unequal capacitors and add a resistor in series with the smaller capacitor. By doing this way, the bandwidth of the loop filter 106 remains pretty much the same but the resistor R₂ 188 of the shunt RC circuit allows some of the step input signal to pass through to speed up the response of the loop filter 106. We should not add the resistor to the larger capacitor since the bandwidth of the loop filter 106 will be changed too much. The improvement of the response time is not significant by adding a shunt RC circuit to the loop capacitor but it is the easiest thing to do to speed up the response time of the loop filter 106. It is very important to exam the frequency response of the loop filter 106 after the loop filter 106 is designed to make sure that the improvement of response time is real instead of at the expense of bandwidth.

The design engineer should spend more time to investigate all the possible designs for the loop filter 106 and to select a filter such as a Gaussian low pass filter that can not only remove the unwanted digital signals effectively but also provide a fast step response to improve the loop gain, instead of simply using the simple RC low pass filter all the time. The simple RC low pass filter is easy to use but it is also very far from the ideal low pass filter for the arrival-time locked loop 100. A Gaussian low pass filter, providing the same bandwidth as a simple RC low pass filter, can use a smaller loop capacitor so that the Gaussian low pass filter can produce more gain for the loop.

In the traditional PLL using PFD 132 with double-ended charge pump output driver, the output from the charge pump output driver to the loop filter 106 is always a constant, fixed pulses train. This is because the two input signals to the PFD 132 will never arrive at the same time in order to avoid the dead-zone jittering problem. As a result, a fixed pulse train output, consisting of a short positive pulse and a short negative pulse, is always generated by the PFD 132 and it depends upon the loop filter 106 to remove the pulses so that these pulses will not modulate the VCO to create phase noise problem for the VCO. Since the short positive pulse and the short negative pulse of the pulse train are simply canceling each other, the sum of the time period duration of the positive pulse and the negative pulse becomes an extra latency delay time for the loop.

For an arrival-time locked loop 100 using a digital arrival-time detector 116, since there is no dead zone jittering problem, the two input signals to the digital arrival-time detector 116 will always arrive at the same time. As a result, the output from the digital arrival-time detector 116 is produced by the random phase noise signals. The pulse width of the output signals from the digital arrival-time detector 116 totally depends upon the phase noise in the system and also upon the extra time we add in addition to the arrival-time difference to the final enable signal 147 and 144 for the charge pump output driver. It is quite evident that the extra time we add to the final enable signal 147 and 144 should be just enough to overcome the dead zone and the linear state. Excess enabling time for the charge pump output driver will only generate more noises to the VCO. It is also quite evident that the digital arrival-time detector 116 can produce much less phase noise for the VCO since the minimum pulse width from the digital arrival-time detector 116 is zero instead of a fixed constant pulse train.

Due to the loop delay time, the timing of the error output signal 114 from the digital arrival-time detector's output and the timing of the signal from VCO 112 at the digital arrival-time detector's input are spaced with an offset time period equal to the loop delay time. This offset time period is the most important factor to determine how the loop will behave during the acquisition process.

The frequency of the last beat signal of the cycle-slip phase 542 is also called the natural frequency of the arrival-time locked loop 100. This is because if the arrival-time locked loop 100 does not damp the last beat signal of the cycle-slip phase 542 properly during the acquiring/locking phase 544 or we should say if the arrival-time locked loop 100 fails to correct the last beat signal of the cycle-slip phase 542 during the acquiring/locking phase 544, then the last beat signal of the cycle-slip phase 542 can continue forever as the resonant frequency of the loop. The last beat signal of the cycle-slip phase 542 is actually the beginning of the whole acquisition process. The operation of the arrival-time locked loop 100 during the period of the last beat signal of the cycle-slip phase 542 determines the performance of the arrival-time locked loop 100 for the rest of the acquisition process in the acquiring/locking phase 544.

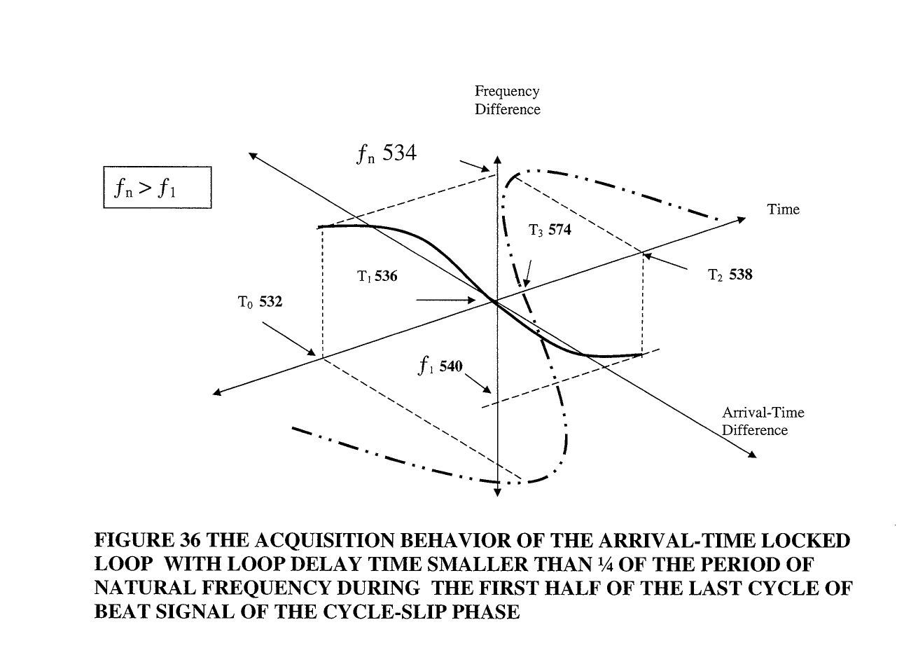

The acquisition process of an actual arrival-time locked loop 100, with some loop delay time less than ¼ of the period of the last beat signal during the last beat signal period of the cycle-slip phase 542, is shown in FIG. 36. In this figure, the signal from VCO 112 at the arrival-time detector's input is assumed to occur at a time (T₂−T₃) later than the output of the arrival-time detector 104 due to the loop delay time. As a result, the net frequency correction to the VCO during the last beat signal period is much less than correction occurred in the ideal arrival-time locked loop 100 without loop delay as shown in the FIG. 31. When there is no loop delay time, all the arrival-time corrections for VCO during the last beat signal period which begins at T₀ 532 and ends at T₂ 538 are all positive so that the frequency difference f₁ 540 at T₂ 538, is much less than the initial frequency difference fₙ 534. With the presence of loop delay time, the net frequency correction to the VCO will be less during the last beat signal period between T₀ 532 and T₂ 538 because the arrival-time detector 104 sends out negative arrival-time corrections between the time of T₂ 538 and T₃ 574. If the net negative frequency correction sent to the VCO between the time of T₂ 538 and T₃ 574 is less than the net positive frequency correction sent to the VCO between the time of T₀ 532 and T₃ 574, then the amount of frequency difference f₁ 540 at the end of the last beat signal period of the cycle-slip phase will be still smaller than fₙ 534 and the arrival-time locked loop 100 will still be able to acquire and lock the signals eventually but the process will take a lot more time. Since the frequency difference at the end of the last beat signal at T₂ 538 is now negative, any positive frequency correction to the VCO between the time of T₀ 532 and T₂ 538 will help to reduce the frequency difference f₁ 540 and help the loop to “damp the acquisition process”.

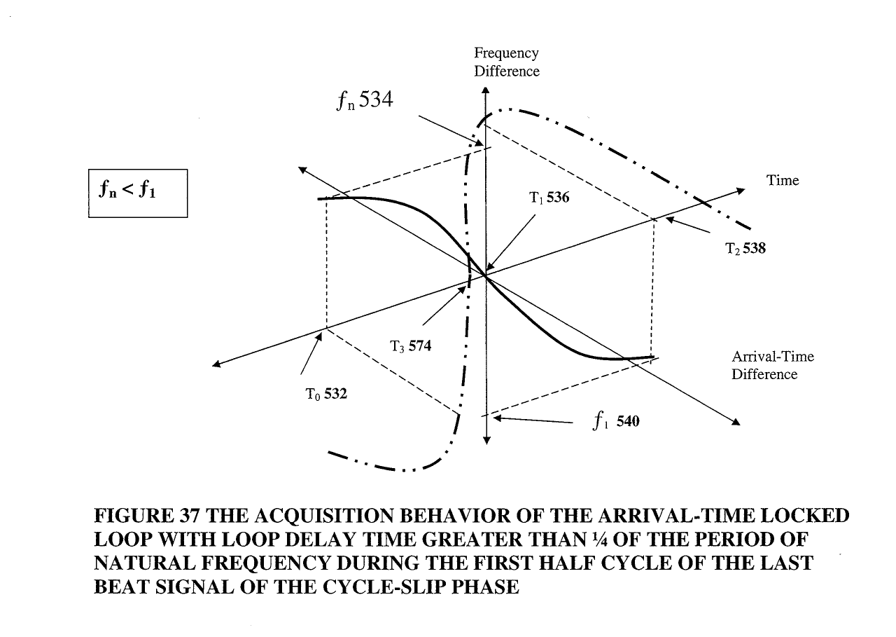

If the loop delay time increases so much that T₂−T₃ is longer than ¼ of the period of the last beat signal of the cycle-slip phase 542 as shown in FIG. 37, then the net frequency correction to the VCO during the last beat signal period of the cycle-slip phase 542 between T₀ 532 and T₂ 538 will be negative. So the frequency difference at the end of the last beat signal f₁ 540 will be larger than initial frequency difference fₙ 534 and the loop will never acquire and lock the signals because the frequency difference does not converge. It is quite evident that the loop delay time must be less than ¼ of the period of the last beat signal of the cycle-slip phase 542 or the natural frequency fₙ 534 of the arrival-time locked loop 100 if the acquisition process is to be successful.

If the loop delay time is increased to a point that T₂−T₃ is exactly equal to ¼ of the period of the last beast signal of the cycle-slip phase 542, then the net frequency correction to the VCO during the last beat signal period between T₀ 532 and T₂ 538 is zero so that the frequency difference at the end of the last beat signal f₁ 540 is exactly the same as the initial frequency difference of the last beat signal fₙ 534 and the loop will oscillate forever at the same rate.

The frequency of the last beat signal of the cycle-slip phase 542 can then be represented by the following equation,

f(t)=fₙ COS (ωₙt)=(ωₙ/2π) COS (ωₙt) equ. 12

And both the amplitude and frequency of the last beat signal of the cycle-slip phase 542 is equal to the natural frequency fₙ 534 of the arrival-time locked loop 100. During the cycle-slip phase 542 of the acquisition process, the frequency difference between the two input signals will become lower and lower as the frequency difference between the two signals continues to be corrected by the arrival-time locked loop 100. The frequency of the last beat signal of the cycle-slip phase 542 is determined by how fast the frequency of the VCO 108 is being corrected during the cycle-slip phase 542. The rate or speed of VCO correction, was also called slew rate 546 of the VCO before, determines the frequency of the last beat signal. Because the last beat signal of the cycle-slip phase 542 can continue forever if the arrival-time locked loop 100 does not damp the last beat signal of the cycle-slip phase 542 properly during the acquiring/locking phase 544, the period of the last beat signal of the cycle-slip phase 542 is equal to 2π/ωₙ so that ωₙ/2π 534 is both the amplitude and frequency of the last beat signal.

Since the frequency of the reference signal 110 is fixed, the frequency changes of the beat signal are generated completely by the frequency changes of the VCO, so if we take the derivative of equation 12 vs. time, we will have the equation for the slew rate of the VCO as

$$\frac{d f ( t )}{d t} = {f}_{n} * {ω}_{n} * SIN ( {ω}_{n} t ) \qquad equ . 13$$

And we need to make sure that the arrival-time locked loop 100 can produce enough output to support the maximum slew rate for the VCO so that the following equation must be satisfied.

$${f}_{n} * {ω}_{n} = \frac{{ω}_{n}^{2}}{2 π} = \frac{{I}_{out}}{C} * {K}_{VCO} \qquad equ . 14$$

Where Iₒᵤₜ is the charge pump output current from the arrival-time detector 104 in Ampere, C is the capacitance of the loop filter in Farad and Kvco is the tuning sensitivity of the VCO in 1/(sec*Volt). In equation 14, we have derived the same formula for ωₙ² as the traditional feedback control theory but without using the feedback control theory. In the traditional feedback control theory, the 2π on the left side of equation 14 was moved to the right side and was included in the VCO sensitivity so that the VCO sensitivity was defined as rad/(sec*Volt). This is completely wrong. The equation 14 should be read as is written above in equation 14. On the right side, it is the VCO slew rate 546 which is a multiplication product of the gain of the loop times the VCO sensitivity. One the left side, it is the natural frequency of the loop times the natural angular frequency of the loop which indicates how fast the natural frequency can move.

Since the frequency correction to the frequency of VCO during the first half of the last beat signal period of the cycle-slip phase 542 is equal to the total amount of arrival-time correction sent out to the VCO during this period. We can calculate the total arrival-time correction T_{correction} sent to the VCO as follows,

$$\begin{matrix}{T}_{correction} = [ \begin{matrix}{\int }_{( {T}_{D} + {T}_{L} ) * {ω}_{n}}^{π} SIN ( t ) d t - \\ {\int }_{0}^{( {T}_{D} + {T}_{L} ) * {ω}_{n}} SIN ( t ) d t\end{matrix} ] * T max & equ . 15 \\ T max = \frac{1}{{ω}_{REF}} & equ 16\end{matrix}$$

The equation 16 for Tₘₐₓ 560 can be derived from the arrival-time difference at the beginning of the second arrival-time comparison cycle after time=T₀ 532 when the arrival-time difference is ΔT₁=2*π*ωₙ/ω_{REF}*ω_{VCO}) as shown in equation 6. Since the arrival-time difference ΔT₁ is also equal to Tₘₐₓ*SIN (ωₙ*2*π/ω_{VCO}) and ω_{VCO>>}ωₙ, the Tmax is approximately equal to 1/ω_{REF}.

where ω_{REF} is the angular frequency of the reference signal 110, T_{D} is the propagation delay time of the loop and T_{L} is the latency delay time of the loop. The total arrival-time correction occurred in the first half cycle of the last beat signal of the cycle-slip phase is then equal to

$${T}_{correction} = \frac{2}{{ω}_{REF}} [ COS ( ( {T}_{D} + {T}_{L} ) {ω}_{n} ) ] \qquad equ . 17$$

It is quite evident that the maximum frequency correction to the VCO occurs when the loop delay time is zero and the frequency correction will still be positive when (T_{D}+T_{L})*ωₙ is less than π/2 so that the period of natural frequency of the loop must be larger than four times the loop delay time in order to be able to acquire and lock the VCO to the reference input signal 110. And the total frequency correction occurred during the first half cycle of the last beat signal of the cycle-slip phase 542 can be calculated by multiply T_{correction} with the VCO slew rate and it is

$${F}_{correction} = \frac{{ω}_{n}^{2}}{2 * π * {ω}_{REF}} * 2 * [ COS ( ( {T}_{D} + {T}_{L} ) {ω}_{n} ) ] \qquad equ . 18$$

From equation 18, we can find out the optimal natural frequency for the loop by taking the derivative of equation 18 with respect to the natural frequency and make it to zero and it is

COT(ωₙ(T_{D}+T_{L}))=2*ωₙ(T_{D}+T_{L}) equ. 19

Equation 19 can only be solved numerically and the solution is approximately equal to

ωₙ(T_{D}+T_{L})=1.076875 equ. 20

So the optimal natural frequency should have a period of 5.835*(T_{D}+T_{L}) and the period of the natural frequency must be at least four times of loop delay time (T_{D}+T_{L}).

The procedure to design the arrival-time locked loop 111 with a frequency divider in the feedback path can then be summarized as follows,

1. To determine the minimum operating frequency of the VCO.

2. To determine the maximum division of the frequency divider in the feedback path.

3. The slowest frequency of the arrival-time comparison signal is equal to the minimum operating frequency of the VCO divided by the maximum division of the frequency divider.

4. The maximum loop delay time is equal to twice the period of the slowest arrival-time comparison signal.

5. The natural frequency of the loop must have a period longer than four times the maximum loop delay time. Considering the tolerance of the components, we can select the period of natural frequency of the loop to be five times the maximum loop delay time.

6. From the natural frequency of the loop and the VCO sensitivity and the charge pump output current capacity, we can find out the desired loop capacitance.

7. We can add a shunt RC circuit or use a Gaussian low pass filter to reduce the size of the capacitance of loop filter to improve the loop gain. Either way, the bandwidth of the filter should remain the same.

8. We need to make sure that the slew rate of the VCO of the loop is higher than the slew rate of the input signals and the equation 11 is not violated.

If there is no frequency divider in the feedback path and the frequency of the arrival-time comparison signal is high, then all the latency delay time and propagation delay time of the flip-flops and arrival-time detector should be added into the maximum loop delay time in the step 4, in addition to twice the period of the slower arrival-time comparison signal.

In a conclusion, the design of the arrival-time locked loop starts by calculating the maximum loop delay time which is equal to twice the period of the slowest arrival-time comparison signal and then continues to calculate the period of the natural frequency of the loop which is equal to at least four times the maximum loop delay time and ends when the decision for the capacitance of the loop filter is made.

### Feedback Control Loop

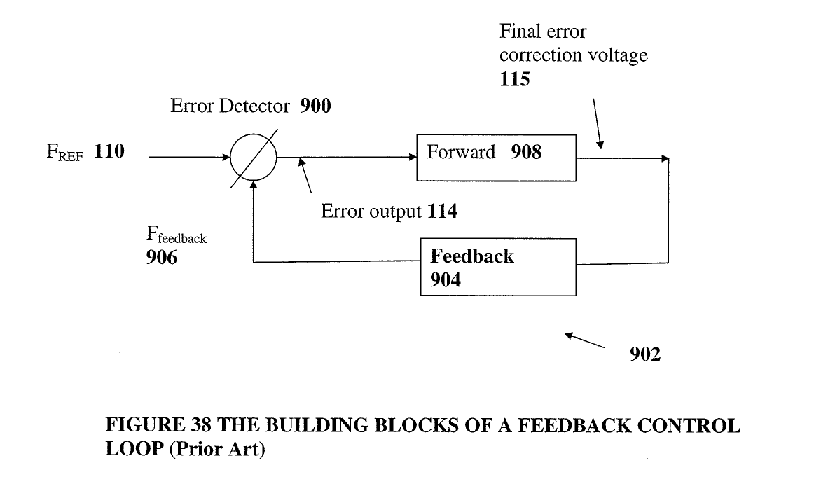

The technique and method to analyze the arrival-time locked loop proposed in this disclosure can also be applied to the general feedback control loop 902. A typical feedback control loop 902 as shown in FIG. 38 includes three modules, the error detector 900, forward module 908 and feedback module 904. We were all taught that a typical feedback control loop system 902 requires a reference input 110 and a feedback signal 906 generated from the feedback module 904 and the goal of the feedback control loop system is to maintain a zero error output 114 at the output of the error detector 900. As a result, in the traditional analysis for the feedback control loop 902, the reference input 110 is the input to the feedback control loop system 902 and the error output signal 114 of the error detector 900 or the final error correction output 115 at the output of the forward module 908 is the output of the system. All the textbooks and all the theory of feedback control system were developed based on this premise. However, as we have learned from this disclosure, the input to the feedback control loop system 902 should be the error signal between the reference input 110 and feedback signal 906 and the final error correction output 115 at the output of the forward module is the actual output of the feedback control loop we should study. Once we derive the transfer characteristics for the output of the feedback control loop, we can take the derivative of the output vs. the derivative of the input and to derive the loop gain easily. Only by this way, we can see clearly how the feedback control loop operates. Only by this definition of input and output of the feedback control loop, we can calculate the gain of the feedback control loop by taking the derivative of the output divided by the derivative of input and the result of the gain is truly meaningful. And the gain of the feedback control loop must satisfy the following two conditions,

1. The gain of the feedback control loop must be non-negative under any circumstance if we use only positive logic to describe the function of each component of the loop.

2. The gain of the feedback control loop must be higher than a certain minimum in order to provide a capturing ability.

For a second order loop that tracks two independent variables at the same time, if we multiply the gain of the loop with the transfer function of the feedback module 904, the result of the multiplication is the slewing ability of the loop which is equal to the natural frequency of the loop times the natural angular frequency of the loop. The slewing ability of the loop indicates how agile the loop is. The slewing ability of the loop indicates how powerful the loop is.

For a first order loop that only tracks a single variable, if we multiply the gain of the loop with the transfer function of the feedback module 904, the result of the multiplication is the tracking ability of the loop which indicates how closely the feedback signal 906 follows the reference input signal 110.

In the traditional feedback control loop theory, there are two kinds of loop gain used in the analysis of the loop, the open loop gain and closed loop gain. Since these two terms really do not have much real meaning in the physical world, we have not used them in this disclosure. Instead, we simply define the final error correction output of the forward module 908 as the output of the feedback control loop 902 and the error signal between the reference input 110 and feedback signal 906 as the input of the feedback control loop 902. With these two definitions, there is only one gain for the loop that is equal to the derivative of the output vs. the derivative of the input. When we multiply the gain of the loop with the transfer characteristic of the feedback module, the result of the multiplication will have a different meaning when a different kind of feedback control loop is analyzed as illustrated in the above.

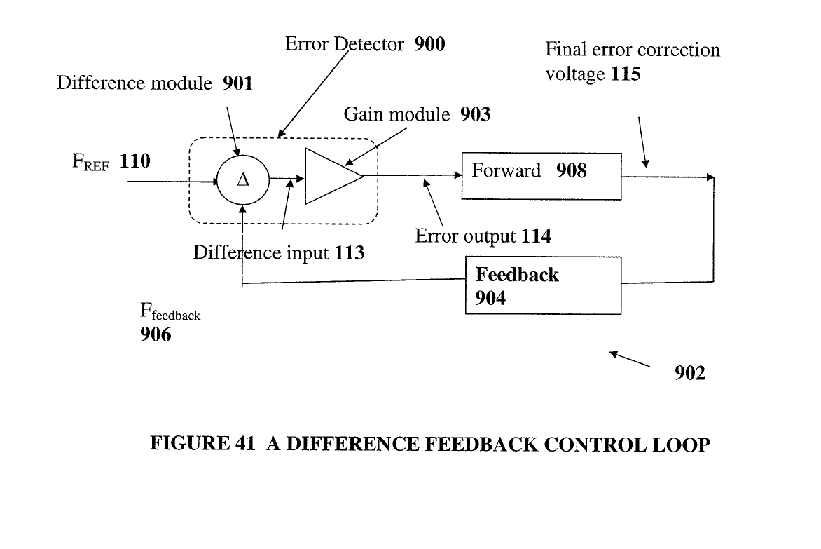

FIG. 41 shows a difference feedback loop of this invention. In the difference feedback loop the error detector 900 is comprised of two parts, a difference module 901 and a gain module 903. The input to the difference module 901 are the reference signal 110 and the feedback signal 906. The output of the difference module 901 is the difference input signal 113 that is the input signal to the gain module 903. The output of the system is the final error correction voltage 115. The reference input signal 110 is actually not part of the feedback control loop but the difference input signal 113 is. The feedback control loop starts from the error detector 900, through the forward module 908 and then through the feedback module 904 back to the error detector 900 to make a complete loop. The reference signal 110 is only a branch input to the error detector 900 but it is not part of the feedback control loop.

### ALTERNATIVE EMBODIMENT

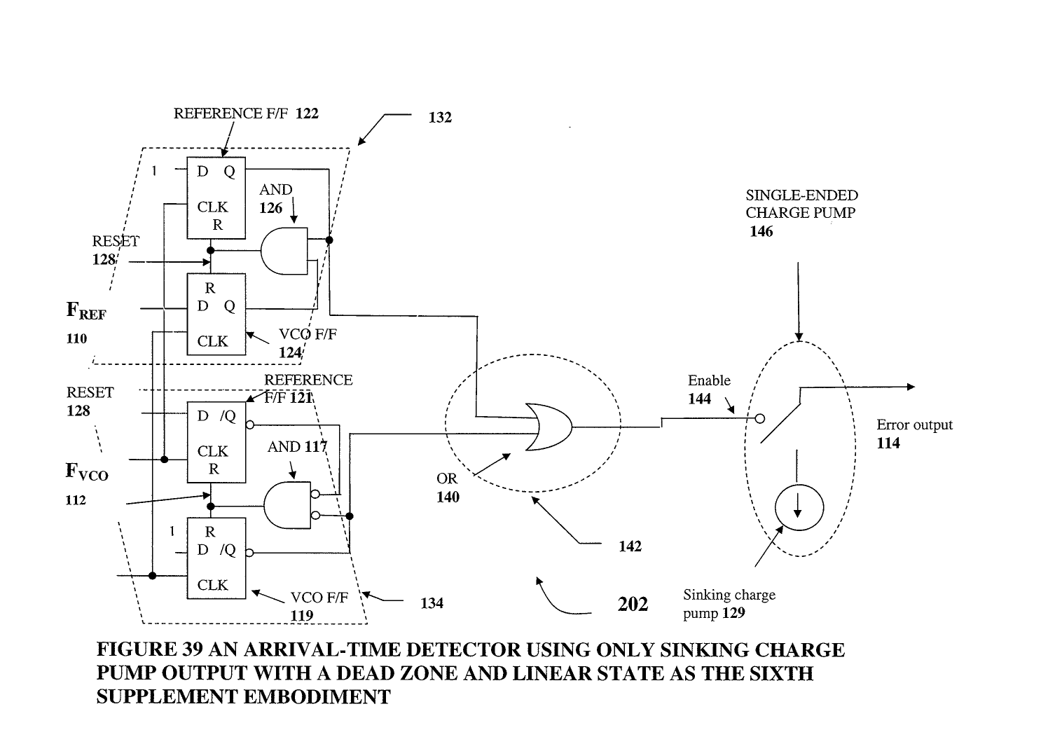

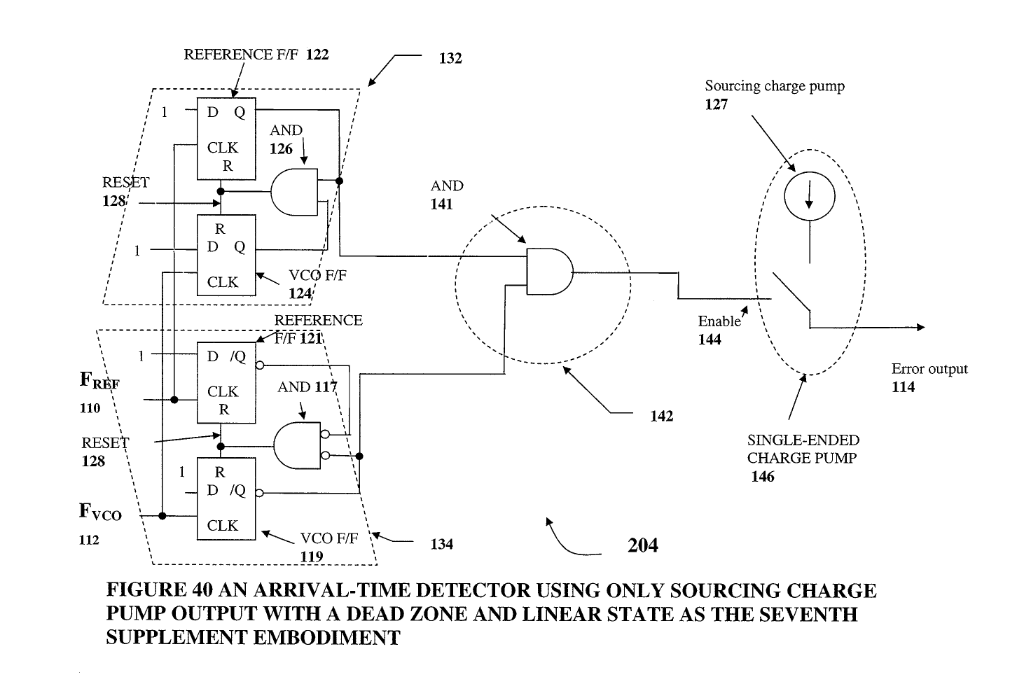

Two alternative embodiments for the designs of arrival-time detector with single-ended charge pump output are shown in FIGS. 39 and 40. The schematics for an arrival-time detector using only a sinking charge pump as the output driver with a dead zone and linear state is shown in FIG. 39 and the schematics for an arrival-time detector using only a sourcing charge pump output driver with a dead zone and linear state is shown in FIG. 40. These two designs can then be combined to become an arrival-time detector using balanced double-ended charge pump output with a dead zone and linear state as shown in FIG. 22. These two designs of arrival-time detector as shown in FIGS. 39 and 40 use the minimum possible components to make an arrival-time detector with a single-ended charge pump output.

### INDUSTRIAL APPLICABILITY

In the field of consumer electronics, such as PCs, laptops, printers, digital camera and cell phones etc., there is a significant demand for a stable clock with the least amount of frequency jitter. These products can all benefit significantly from these inventions by producing stable signal source that is guaranteed to be free from the dead-zone jittering problem by design.

What is claimed:

1. An arrival-time locked loop, comprising:
an arrival-time detector having at least two input terminals and an output terminal;
a loop filter having an input terminal and an output terminal and wherein said loop filter input terminal is connected to said output terminal of said arrival-time detector; and
a voltage controlled oscillator (VCO) having an input terminal and an output terminal, and wherein said VCO input terminal is connected to said output terminal of said loop-filter, and wherein said output terminal of said VCO is connected to one of said input terminals to said arrival-time detector.

2. The arrival-time locked loop of claim 1 further comprising a reference signal input to said arrival time detector and an output signal of said VCO input to said arrival time detector; and an error output signal from said arrival-time detector.

3. The arrival-time locked loop of claim 2 wherein said error output signal is a positive signal if an arrival time of said reference signal precedes an arrival time of said VCO output signal, and wherein a frequency of said VCO output signal increases responsive to said positive signal.

4. The arrival-time locked loop of claim 3 wherein said error output signal is a negative signal if an arrival time of said reference signal lags an arrival time of said VCO output signal, and wherein a frequency of said VCO output signal decreases responsive to said negative signal.

5. The arrival-time locked loop of claim 4 wherein a magnitude of a VCO input signal derived from said positive signal is proportional to a time difference by which said arrival time of said reference signal precedes said arrival time of said VCO output signal.

6. The arrival-time locked loop of claim 5 wherein a magnitude of a VCO input signal derived from said negative signal is proportional to a time difference by which said arrival time of said reference signal lags said arrival time of said VCO output signal.

7. The arrival-time locked loop of claim 6 wherein said arrival-time detector comprises a normal phase-frequency detector (PFD), a complementary PFD, a polarity selection circuit and a charge pump.

8. The arrival-time locked loop of claim 7 wherein said polarity selection circuit comprises a first AND gate, a second AND gate, a first OR gate and a second OR gate, and wherein said charge pump is a double ended charge pump comprising a sourcing charge pump and a sinking charge pump.

9. The arrival-time locked loop of claim 8 wherein an output terminal of said normal PFD is connected to an input terminal of said first AND gate, an output terminal of said complementary PFD is connected to an input terminal of said first OR gate, an output terminal of said second AND gate is connected to an enabling terminal of said sourcing charge pump and an output terminal of said second OR gate is connected to an enabling terminal of said sinking charge pump.

10. The arrival-time locked loop of claim 7 wherein said polarity selection circuit comprises an AND gate and an OR gate, and wherein said charge pump is a double ended charge pump comprising a sourcing charge pump and a sinking charge pump. (THIS IS FIG. 22).

11. The arrival-time locked loop of claim 10 wherein an output terminal of said normal PFD is connected to an input terminal of said AND gate, an output terminal of said complementary PFD is connected to an input terminal of said OR gate, an output terminal of said AND gate is connected to an enabling terminal of said sourcing charge pump and an output terminal of said OR gate is connected to an enabling terminal of said sinking charge pump.

12. The arrival-time locked loop of claim 8 wherein an output terminal of said normal PFD is connected to an input terminal of said first AND gate, an output terminal of said complementary PFD is connected to an input terminal of said first OR gate, an output terminal of said second AND gate is connected to an enabling terminal of said sourcing charge pump via a first reduces and an output terminal of said second OR gate is connected to an enabling terminal of said sinking charge pump via a second reducer.

13. The arrival-time locked loop of claim 1 further comprising a frequency divider and wherein said output terminal of said VCO is connected to an input terminal of said frequency divider and an output terminal of said frequency divider is connected to said input terminal of said arrival time detector.

14. The arrival-time locked loop of claim 13 wherein said frequency divider is a divide by N frequency divider.

15. The arrival-time locked loop of claim 7 wherein said polarity selection circuit comprises an OR gate and wherein said charge pump is a single ended charge pump comprising a sinking charge pump.

16. The arrival-time locked loop of claim 15 wherein an output terminal of said normal PFD is connected to a first input terminal of said OR gate, an output terminal of said complementary PFD is connected to a second input terminal of said OR gate, and an output terminal of said OR gate is connected to an enabling terminal of said sinking charge pump.

17. The arrival-time locked loop of claim 7 wherein said polarity selection circuit comprises an AND gate and wherein said charge pump is a single ended charge pump comprising a sourcing charge pump.

18. The arrival-time locked loop of claim 17 wherein an output terminal of said normal PFD is connected to a first input terminal of said AND gate, an output terminal of said complementary PFD is connected to a second input terminal of said AND gate, and an output terminal of said AND gate is connected to an enabling terminal of said sourcing charge pump.

19. The arrival-time locked loop of claim 1 having a natural frequency and a total loop delay time, said natural frequency comprising a beat signal of a cycle-slip phase, said total loop delay comprising the sum of a latency delay time of said arrival-time locked loop and a propagation delay time of said arrival-time locked loop, and wherein a period of said natural frequency is at least four times said total loop delay.

20. A feed-back control loop having an error detector, a forward unit and a feedback unit, and wherein an input to said feedback control loop comprises a difference between a reference signal and a signal from said feedback unit, an output from said feedback loop comprises an output from said forward unit and wherein a gain of said feed-back control loop comprises a derivative of said output with respect to said input.
